(19) United States
(12) Patent Application Publication
(10) Pub. No.: US 2026/0365012 A1
(43) Pub. Date: Nov. 19, 2026

(54) ELECTRIC WORKING VEHICLE

(71) Applicant: Kubota Corporation, Osaka (JP)

(72) Inventors: Shotaro KAWAHATA, Fremont, CA (US); Hiroaki HOSOZAWA, Fremont, CA (US)

(21) Appl. No.: 19/425,952

(22) Filed: Dec. 18, 2025

Related U.S. Application Data
(60) Provisional application No. 63/806,910, filed on May 16, 2025.

(51) Int. Cl. B60K 17/28; B60L 1/00; B60L 58/14

(52) U.S. Cl. CPC B60K 17/28; B60L 1/003; B60L 58/14; B60L 2200/40; B60L 2240/547

(57) ABSTRACT

A controller of an electric working vehicle is configured or programmed to perform a work-and-travel in which the controller causes at least one motor-for-travel to drive driving wheels to cause a vehicle body to travel and causes a working device connected to the vehicle body to perform work in an agricultural field, determine a type of the working device based on device information input via an input interface, and according to a state of charge of a battery detected by a battery management system and the type of the working device, control at least one of a motor-for-PTO or a lift actuator to cause the working device to stop performing the work.

### CROSS-REFERENCE TO RELATED APPLICATIONS

This application claims the benefit of priority to U.S. Provisional Patent Application No. 63/806,910 filed on May 16, 2025. The entire contents of this application are hereby incorporated herein by reference.

### BACKGROUND OF THE INVENTION

### 1. Field of the Invention

The present invention relates to energy management techniques for electric working vehicles to be driven using electric power stored in a battery as energy.

### 2. Description of the Related Art

For example, Japanese U.S. Pat. No. 7,409,355 discloses an electric tractor in which a working device including a rotor is connected to a vehicle body and that includes a plurality of electric motors that drive wheels for travel and the rotor, and a control device that causes a plurality of inverters to control electric power supplied from a battery to the respective electric motors. The control device calculates an estimated state of charge of the battery when it is assumed that work in an agricultural field is finished according to the work content or the like, and controls each inverter such that the input/output electric power of the battery is within a specified range of electric power when the estimated state of charge is less than a second specified state of charge (limit process). When the current state of charge of the battery is less than a first specified state of charge (<second specified state of charge), the control device controls an inverter for PTO to stop rotating an electric motor for PTO and a PTO shaft to stop driving the rotor of the working device (forced stop process).

In the technique of related art as described above, when a working device that does not support a power take-off system is connected to the electric working vehicle, the electric working vehicle needs to stop traveling in order to cause the working device to stop performing the work, leading to low flexibility of power saving. Accordingly, example embodiments of the present invention were conceived of and developed to improve the flexibility of power saving of an electric working vehicle.

### SUMMARY OF THE INVENTION

An electric working vehicle according to an example embodiment of the present invention includes driving wheels for travel attached to a vehicle body, at least one motor-for-travel which is at least one electric motor to drive the driving wheels, a battery, at least one inverter-for-travel to supply electric power from the battery to the at least one motor-for-travel to drive the at least one motor-for-travel, a PTO shaft, a motor-for-PTO which is an electric motor to drive the PTO shaft, an inverter-for-PTO to supply electric power from the battery to the motor-for-PTO to drive the motor-for-PTO, a battery management system to monitor a state of the battery, an input interface to receive input of device information relating to a working device connected to the vehicle body, and a controller configured or programmed to cause the at least one inverter-for-travel to control the at least one motor-for-travel, cause the inverter-for-PTO to control the motor-for-PTO, and control a lift actuator to raise and lower the working device, wherein the controller is configured or programmed to perform a work-and-travel in which the controller causes the at least one motor-for-travel to drive the driving wheels to cause the vehicle body to travel and causes the working device to perform work in an agricultural field, determine a type of the working device based on the device information, and according to a state of charge of the battery detected by the battery management system and the type of the working device, control at least one of the motor-for-PTO or the lift actuator to cause the working device to stop performing the work.

In an example embodiment of the present invention, the controller may be configured or programmed to perform the work-and-travel when the state of charge is equal to or greater than a first threshold, when the state of charge is less than the first threshold, perform the work-and-travel while limiting the electric power supplied by the at least one inverter-for-travel to the at least one motor-for-travel, and when the state of charge is less than a second threshold which is less than the first threshold during the work-and-travel, control at least one of the motor-for-PTO or the lift actuator based on the type of the working device to stop the work and continue to cause the vehicle body to travel.

In an example embodiment of the present invention the controller may be configured or programmed to, when the state of charge is less than a threshold, control at least one of the motor-for-PTO or the lift actuator based on the type of the working device to stop the work.

In an example embodiment of the present invention, the controller may be configured or programmed to, when the state of charge is less than a threshold during the work-and-travel, perform at least one of a first stop control or a second stop control based on the type of the working device to stop the work. The controller may be configured or programmed to, in the first stop control, cause the inverter-for-PTO and the motor-for-PTO to stop driving the PTO shaft to stop driving a rotor of the working device connected to the PTO shaft, and in the second stop control, cause the lift actuator to raise the working device to bring the working device into a predetermined position in which at least a work tool of the working device is not in contact with a ground surface.

In an example embodiment of the present invention, the controller may be configured or programmed to perform the first stop control when the type of the working device is a first working device to be driven by a driving force of the PTO shaft, and perform the second stop control when the type of the working device is a second working device to be raised and lowered by the lift actuator and to perform the work while in contact with the ground surface.

In an example embodiment of the present invention, the controller may be configured or programmed to, when the type of the working device is the first working device, cause a user interface to output first information asking whether stopping the PTO shaft is acceptable or not, and perform the first stop control when an instruction to accept stopping the PTO shaft is received via the user interface.

In an example embodiment of the present invention, the electric working vehicle may further include a position detector to detect a position of the vehicle body using a satellite positioning system. The controller may be configured or programmed to, when an instruction to not accept stopping the PTO shaft is received via the user interface, calculate estimated electric power consumption which is an electric power estimated to be consumed by the electric working vehicle if the work-and-travel is continued until the vehicle body reaches a first predetermined point, and perform the first stop control if the estimated electric power consumption is equal to or greater than a first permissible value.

In an example embodiment of the present invention, the controller may be configured or programmed to continue the work-and-travel if the estimated electric power consumption is less than the first permissible value, and perform the first stop control when the vehicle body reaches the first predetermined point.

In an example embodiment of the present invention, the electric working vehicle may further include at least one of a memory or a storage to store a planned travel route for the vehicle body to travel and for the working device to perform the work in the agricultural field. The controller may be configured or programmed to, while performing the work-and-travel based on the planned travel route, determine that the first predetermined point is one of end points of straight portions included in the planned travel route that is present in a direction of travel of the vehicle body and that is closest from a position of the vehicle body, calculate an estimated travel distance to be traveled by the vehicle body to reach the one of the end points that is closest from the position of the vehicle body based on the planned travel route, and calculate the estimated electric power consumption corresponding to the first working device based on the estimated travel distance.

In an example embodiment of the present invention, the controller may be configured or programmed to, when the type of the working device is the second working device, cause a user interface to output second information asking whether raising the working device is acceptable or not, and perform the second stop control when an instruction to accept raising the working device is received via the user interface.

In an example embodiment of the present invention, the electric working vehicle may further include a position detector to detect a position of the vehicle body using a satellite positioning system. The controller may be configured or programmed to, when an instruction to not accept raising the working device is received via the user interface, calculate estimated electric power consumption which is an electric power estimated to be consumed by the electric working vehicle if the work-and-travel is continued until the vehicle body reaches a first predetermined point, and perform the second stop control if the estimated electric power consumption is equal to or greater than a second permissible value.

In an example embodiment of the present invention, the controller may be configured or programmed to continue the work-and-travel if the estimated electric power consumption is less than the second permissible value, and perform the second stop control when the vehicle body reaches the first predetermined point.

In an example embodiment of the present invention, the electric working vehicle may further include at least one of a memory or a storage to store a planned travel route for the vehicle body to travel and for the working device to perform the work in the agricultural field. The controller may be configured or programmed to, while performing the work-and-travel based on the planned travel route, determine that the first predetermined point is one of end points of straight portions included in the planned travel route that is present in a direction of travel of the vehicle body and that is closest from a position of the vehicle body, calculate an estimated travel distance to be traveled by the vehicle body to reach the one of the end points that is closest from the position of the vehicle body based on the planned travel route, and calculate the estimated electric power consumption corresponding to the second working device based on the estimated travel distance.

In an example embodiment of the present invention, the controller may be configured or programmed to, when the type of the working device is a third working device which differs from the first working device and the second working device, cause a user interface to output third information suggesting that the working device be detached from the vehicle body.

In an example embodiment of the present invention, the electric working vehicle may further include a position detector to detect a position of the vehicle body using a satellite positioning system. The controller may be configured or programmed to calculate estimated electric power consumption which is an electric power estimated to be consumed by the electric working vehicle if the work-and-travel or a travel of the electric working vehicle is continued until the vehicle body reaches a second predetermined point, and cause the user interface to output the third information if the estimated electric power consumption is equal to or greater than a third permissible value.

In an example embodiment of the present invention, the electric working vehicle may further include at least one of a memory or a storage to store map information relating to a region including the agricultural field. The controller may be configured or programmed to determine that the second predetermined point is a storage location of the electric working vehicle in the region based on the map information, calculate an estimated travel distance to be traveled if the travel of the electric working vehicle is continued until the vehicle body reaches the storage location based on the map information, and calculate the estimated electric power consumption based on the estimated travel distance.

In an example embodiment of the present invention, the electric working vehicle may further include a position detector to detect a position of the vehicle body using a satellite positioning system, and a communication interface to communicate wirelessly with an external device. The controller may be configured or programmed to calculate a traveled route traveled by the vehicle body and an orientation of the vehicle body based on time-series position data of the vehicle body, when the state of charge is less than a third threshold which is less than the second threshold, generate status information including at least one of the position of the vehicle body, the orientation of the vehicle body, the traveled route, or the device information, and cause the communication interface to transmit the status information to the external device.

In an example embodiment of the present invention, the controller may be configured or programmed to perform a third stop control when the state of charge is less than a third threshold which is less than the second threshold, and in the third stop control, cause the at least one inverter-for-travel and the at least one motor-for-travel to stop rotating the driving wheels to cause the vehicle body to stop traveling.

In an example embodiment of the present invention, the electric working vehicle may further include an externally power-supplying circuit to supply electric power from the battery to an external device. The controller may be configured or programmed to, when the state of charge is less than a threshold and the type of the working device is a fourth working device, perform a fourth stop control to stop the work. The fourth working device may be configured to be driven by the electric power supplied from the externally power-supplying circuit. The controller may be configured or programmed to, in the fourth stop control, stop the electric power from being supplied from the externally power-supplying circuit to the working device by turning off a switch in the externally power-supplying circuit.

In an example embodiment of the present invention, the electric working vehicle may further include a hydraulic pump to deliver hydraulic fluid, a motor-for-pump which is an electric motor to drive the hydraulic pump, an inverter-for-pump to supply electric power from the battery to the motor-for-pump to drive the motor-for-pump, and an externally fluid-supplying circuit to supply the hydraulic fluid to an external device. The controller may be configured or programmed to, when the state of charge is less than a threshold and the type of the working device is a fifth working device, perform a fifth stop control to stop the work. The fifth working device may be configured to be driven by a pressure of the hydraulic fluid supplied from the externally fluid-supplying circuit. The controller may be configured or programmed to, in the fifth stop control, stop the hydraulic fluid from being supplied from the externally fluid-supplying circuit to the working device by closing a control valve provided in the externally fluid-supplying circuit.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a side view of an example of an electric working vehicle.

FIG. 2 is a diagram illustrating an example of a configuration of the electric working vehicle.

FIG. 3 is a schematic diagram illustrating an example of a configuration relating to traveling, steering, and braking of the electric working vehicle.

FIG. 4 is a perspective view illustrating an example of a raising/lowering mechanism.

FIG. 5 is a diagram illustrating an example of a planned travel route for the electric working vehicle.

FIG. 6 is a flowchart presenting an example of an operation of the electric working vehicle.

FIG. 7 is a diagram presenting an example of the relationship between the estimated travel distance to be traveled by the electric working vehicle and the threshold.

FIG. 8A is a flowchart presenting an example of an operation of the electric working vehicle in a forced work-stop mode.

FIG. 8B is a flowchart that continues from FIG. 8A.

FIG. 9 is a view illustrating an example of first information.

FIG. 10 is a view illustrating an example of stop information.

FIG. 11 is a diagram presenting an example of the relationship between the estimated travel distance and the estimated electric power consumption of the electric working vehicle.

FIG. 12 is a diagram presenting an example of control data indicating the correspondence between the type of a working device and the coefficient.

FIG. 13 is a view illustrating an example of second information.

FIG. 14 is a view illustrating an example of third information.

FIG. 15A is a flowchart presenting another example of the operation of the electric working vehicle in the forced work-stop mode.

FIG. 15B is a flowchart that continues from FIG. 15A.

FIG. 16 is a view illustrating an example of the third information.

FIG. 17 is a flowchart presenting another example of the operation of the electric working vehicle.

FIG. 18 is a diagram presenting an example of information transmitted in a data transmission mode of the electric working vehicle.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

Hereinafter, example embodiments of the present invention will be described with reference to the drawings as appropriate.

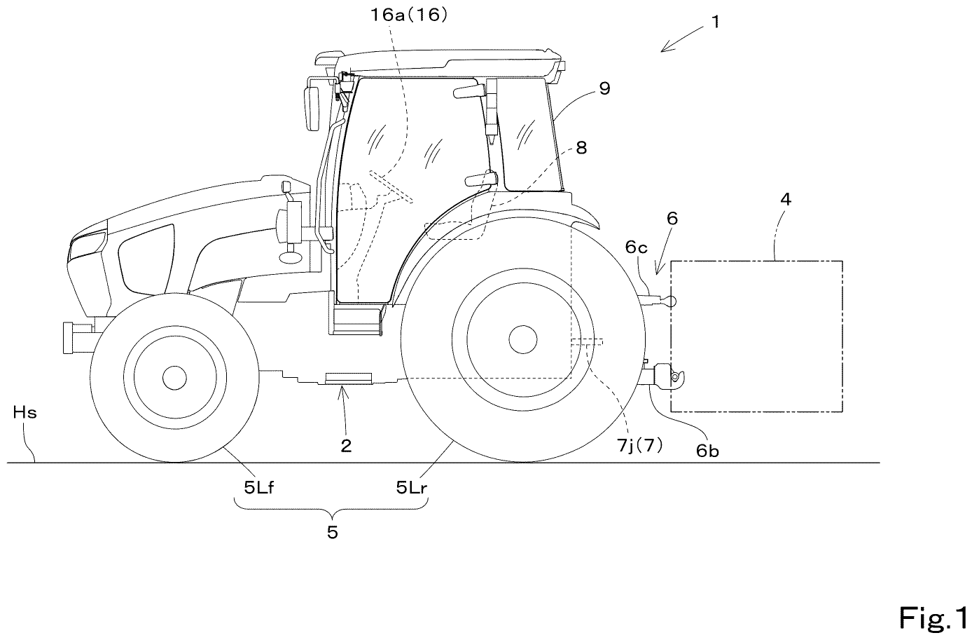

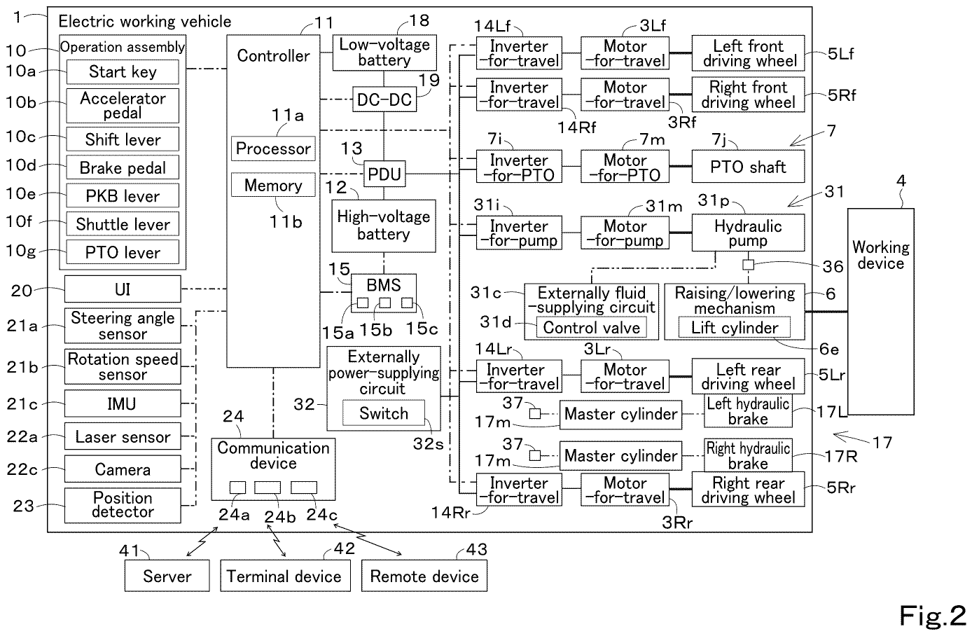

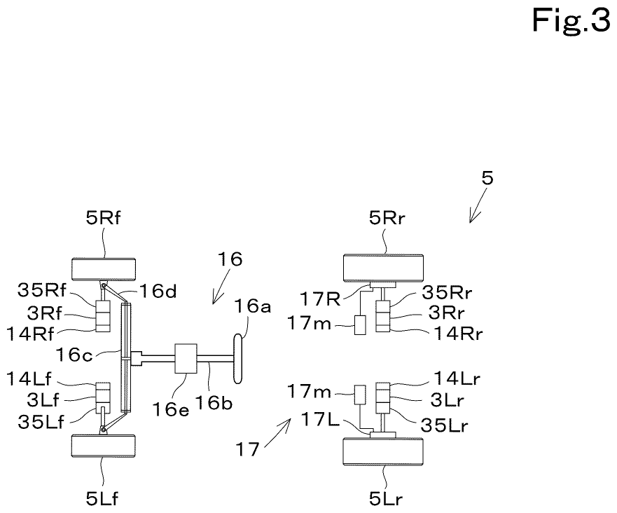

FIG. 1 is a side view of an example of an electric working vehicle 1. FIG. 2 is a diagram illustrating an example of a configuration of the electric working vehicle 1. FIG. 3 is a schematic diagram illustrating an example of a configuration relating to traveling, steering, and braking of the electric working vehicle 1. In the present example embodiment, an electric tractor is illustrated as an example of the electric working vehicle 1. However, electric working vehicles according to example embodiments of the present invention are not limited to electric tractors, and may be electric agricultural machines, electric construction machines, other electric working vehicles, or the like, other than the electric tractor. The leftward direction, the rightward direction, the near-side direction, and the deep-side direction in FIG. 1 are forward, rearward, leftward, and rightward of the electric working vehicle 1, respectively.

As illustrated in FIG. 1, the electric working vehicle 1 includes a vehicle body 2. A cabin 9 is mounted on an upper portion of the vehicle body 2. An operator's seat 8, various operation members, and the like are provided inside the cabin 9. Instead of the cabin 9, a protective structure such as a canopy and/or a ROPS may be provided around the operator's seat 8. The electric working vehicle 1 is capable of manual operation by an operator (driver) seated on the operator's seat 8 and automatic operation. The automatic operation of the electric working vehicle 1 includes autonomous operation (such as autonomous travel) based on a software program and remote operation based on a remote operation signal. During the automatic operation of the electric working vehicle 1, the operator does not have to ride on the electric working vehicle 1. The electric working vehicle 1 of the present example embodiment is a manned working vehicle on which the operator rides and an unmanned working vehicle on which the operator does not ride. However, electric working vehicles according to example embodiments of the present invention may be either manned working vehicles or unmanned working vehicles. When the electric working vehicle is an unmanned working vehicle, the protective structure such as the operator's seat 8 and the cabin 9 may be omitted.

The electric working vehicle 1 includes a plurality of wheels 5Lf, 5Lr, 5Rf, and 5Rr, and a plurality of motors-for-travel 3Lf, 3Lr, 3Rf, and 3Rr. As illustrated in FIG. 3, the plurality of wheels 5Lf, 5Lr, 5Rf, and 5Rr are attached to a front left portion, a front right portion, a rear left portion, and a rear right portion of the vehicle body 2, respectively. Each of the plurality of wheels 5Lf, 5Lr, 5Rf, and 5Rr is a mounted wheel, and includes a tire, an annular rim with the tire fitted on the outer periphery thereof, and a hub located at a central portion of the tire with the rim attached to the axle.

The rotating shafts of the plurality of wheels 5Lf, 5Lr, 5Rf, and 5Rr are connected to the rotating shafts of the motors-for-travel 3Lf, 3Lr, 3Rf, and 3Rr via transmissions 35Lf, 35Lr, 35Rf, and 35Rr (FIG. 3), respectively. The motors-for-travel 3Lf, 3Lr, 3Rf, and 3Rr are electric motors. The plurality of wheels 5Lf, 5Lr, 5Rf, and 5Rr are driving wheels that are rotationally driven by power output from the connected motors-for-travel 3Lf, 3Lr, 3Rf, and 3Rr. The wheels 5Lf, 5Lr, 5Rf, and 5Rr, the transmissions 35Lf, 35Lr, 35Rf, and 35Rr, and the motors-for-travel 3Lf, 3Lr, 3Rf, and 3Rr are included in a traveling system 5 provided in the electric working vehicle 1.

In the present example embodiment, the electric working vehicle 1 includes a plurality of (two) left driving wheels 5Lf and 5Lr for travel attached to a left portion of the vehicle body 2, a plurality of (two) right driving wheels 5Rf and 5Rr for travel attached to a right portion of the vehicle body 2, a plurality of (two) electric motors (first electric motors) 3Lf and 3Lr that drive the left driving wheels 5Lf and 5Lr, and a plurality of (two) electric motors (second electric motors) 3Rf and 3Rr that drive the right driving wheels 5Rf and 5Rr.

As another example, any one of the plurality of wheels 5Lf and 5Lr attached to the left portion of the vehicle body 2 may be a driving wheel, and the other may be a driven wheel. Any one of the plurality of wheels 5Rf and 5Rr attached to the right portion of the vehicle body 2 may be a driving wheel, and the other may be a driven wheel. The driving wheels 5Lf, 5Lr, 5Rf, and 5Rr of the electric working vehicle 1 may be driven by one electric motor. In this case, the electric working vehicle 1 includes at least one left driving wheel 5Lf or 5Lr and at least one right driving wheel 5Rf or 5Rr for travel, and at least one electric motor 3Lf, 3Lr, 3Rf, or 3Rr to drive the at least one driving wheel 5Lf, 5Lr, 5Rf, or 5Rr.

Alternatively, as another example, a pair of left and right crawler type wheels (endless tracks) may be attached to the vehicle body 2 instead of the wheel 5Lr at the rear left portion and the wheel 5Rr at the rear right portion of the vehicle body 2. The crawler type wheels each include a crawler, a driving wheel that drives the crawler in a circulating manner, a driven wheel that rotates according to the drive of the crawler in a circulating manner, a plurality of rolling wheels (idling wheels), and the like. In this case as well, the left driving wheel included in the rear left crawler type wheel and the right driving wheel included in the rear right crawler type wheel are rotationally driven by power output from the respective individual electric motors.

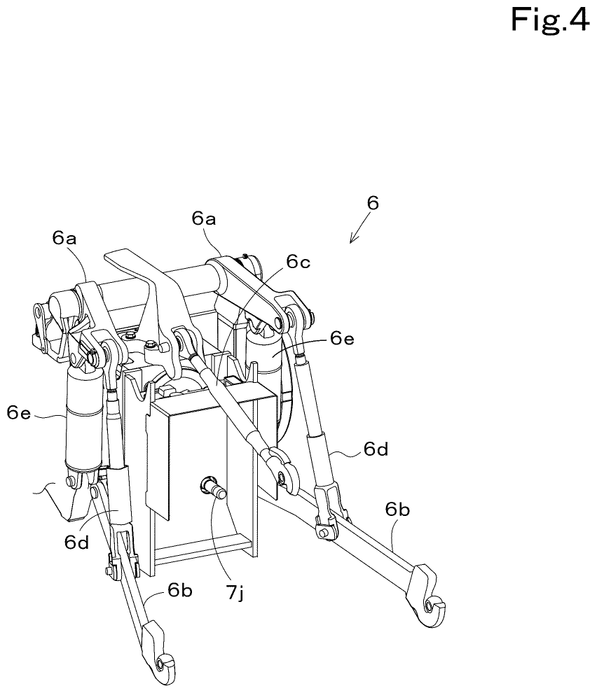

The electric working vehicle 1 includes a raising/lowering mechanism (also referred to as a “raising/lowering device” or a “lift”) 6. FIG. 4 is a perspective view illustrating an example of the raising/lowering mechanism 6. The raising/lowering mechanism 6 is a three-point linkage installed at a rear portion of the vehicle body 2, and a working device 4 for performing work can be attached to and detached from the raising/lowering mechanism 6. The raising/lowering mechanism 6 includes lift arm(s) 6a, lower link(s) 6b, a top link 6c, lift rod(s) 6d, and lift cylinder(s) 6e.

A front end portion (proximal portion) of the lift arm 6a is rotatably connected to the rear portion of the vehicle body 2 via a shaft or the like parallel to the vehicle width direction of the electric working vehicle 1. The lift arm 6a is driven by the lift cylinder 6e to swing in the up-down direction. The lift cylinder 6e is an actuator (lift actuator) included in the raising/lowering mechanism 6, and is a hydraulic cylinder. The lift cylinder 6e is supplied with hydraulic fluid from a hydraulic pump 31p via a control valve 36. The control valve 36 is, for example, a solenoid valve (electromagnetic three-position switching valve) that can be switched to any one of three positions. The control valve 36 controls the supply of the hydraulic fluid from the hydraulic pump 31p to the lift cylinder 6e to actuate the lift cylinder 6e such that the lift cylinder 6e extends and retracts.

A front end portion of the lower link 6b is rotatably connected to the rear portion of the vehicle body 2 via a shaft or the like parallel to the vehicle width direction. A front end portion of the top link 6c is rotatably connected to the rear portion of the vehicle body 2 via a shaft or the like parallel to the vehicle width direction, at a position higher than the lower link 6b. The lift rod 6d is connected to the lift arm 6a and the lower link 6b. The working device 4 is connected to a rear portion of the lower link 6b and a rear portion of the top link 6c.

When the lift cylinder 6e is actuated to extend and retract, the lift arm 6a swings upward and downward, and the lower link 6b connected to the lift arm 6a via the lift rod 6d also swings upward and downward. Accordingly, the working device 4 connected to the lower link 6b and the top link 6c swings upward and downward with the front end portion of the lower link 6b as a fulcrum. That is, the working device 4 is raised and lowered.

As another example, instead of the hydraulic lift cylinder 6e, another actuator such as an electric cylinder or an electric or hydraulic motor may be included in the raising/lowering mechanism 6 or provided in the electric working vehicle 1. Alternatively, instead of the raising/lowering mechanism 6, another linkage (hitch) such as a swing drawer may be installed on the vehicle body 2, and the working device 4 may be connected to the linkage. The working device 4 is connected to the vehicle body 2 (electric working vehicle 1) via the raising/lowering mechanism 6 or the other linkage.

Examples of the working device 4 that can be connected to the vehicle body 2 include a cultivator that performs cultivation work in an agricultural field, a stubble cultivator, a spreader that spreads fertilizer or water, a seeder that sows seeds, seed potatoes, or the like of crops, an earthing up device that performs earthing up work (also referred to as a “ridging device”), a pest control machine that sprays a chemical, a harvester that harvests crops cultivated in an agricultural field, and a pruner that performs pruning. The working device 4 may be an implement defining any one of these or may be an attachment.

The working device 4 includes a work tool, which is, for example, a cultivating blade, an excavating blade, an earth pressing plate, a nozzle, a covering plate, or a cutting blade. There is also a working device 4 including a rotor to which at least one work tool is connected.

Examples of the type of the working device 4 include a ground contact type the working device of which performs work while in contact with the ground surface and a noncontact type the working device of which performs work while not in contact with the ground surface. Examples of the type of the working device 4 include a towed type the working device of which is towed by the electric working vehicle 1 and a directly mounted type the working device of which is supported by the electric working vehicle 1 via the raising/lowering mechanism 6 or the like.

Examples of the type of the working device 4 include a non-driven work type the working device of which performs work only by the propelling power of the electric working vehicle 1, and a driven work type the working device of which performs work that is driven by a driving force (dynamic power, electric power, or hydraulic pressure) output from the electric working vehicle 1 separately from the propelling power. Examples of the working device of the driven work type include a working device (first working device) of a power takeoff (PTO) support type that is driven by the driving force (rotational force) of a PTO shaft 7j included in a PTO system 7 provided in the electric working vehicle 1. Examples of the working device of the non-driven work type or the driven work type include a working device (second working device) of a raised/lowered type and the ground contact type that is raised and lowered by the raising/lowering mechanism 6 (lift cylinder 6e) and that performs work while in contact with the ground surface. In addition to the above, various types of working devices 4 can be connected to the vehicle body 2 (electric working vehicle 1).

As illustrated in FIG. 2, the electric working vehicle 1 includes a high-voltage battery 12 and a plurality of inverters-for-travel 14Lf, 14Rf, 14Lr, and 14Rr. The high-voltage battery 12 is a secondary battery that stores high-voltage electric power, and is a power source of the electric working vehicle 1. The high-voltage battery 12 includes a plurality of battery packs. The plurality of inverters-for-travel 14Lf, 14Rf, 14Lr, and 14Rr correspond to the plurality of motors-for-travel 3Lf, 3Rf, 3Lr, and 3Rr on a one-to-one basis. The inverters-for-travel 14Lf, 14Rf, 14Lr, and 14Rr are drive circuits that supply the electric power from the high-voltage battery 12 to the corresponding motors-for-travel 3Lf, 3Rf, 3Lr, and 3Rr to drive the motors-for-travel 3Lf, 3Rf, 3Lr, and 3Rr, respectively. The inverters-for-travel 14Lf, 14Rf, 14Lr, and 14Rr are included in the traveling system 5 of the electric working vehicle 1.

In the present example embodiment, the electric working vehicle 1 includes at least one inverter (first inverter) 14Lf, 14Lr to supply electric power from the high-voltage battery 12 to the at least one electric motor 3Lf, 3Lr for the at least one left driving wheel 5Lf, 5Lr to drive the at least one electric motor 3Lf, 3Lr, and at least one inverter (second inverter) 14Rf, 14Rr to supply electric power from the high-voltage battery 12 to the at least one electric motor 3Rf, 3Rr for the at least one right driving wheel 5Rf, 5Rr to drive the at least one electric motor 3Rf, 3Rr.

As another example, when the driving wheels 5Lf, 5Lr, 5Rf, and 5Rr of the electric working vehicle 1 are configured to be driven by one electric motor, it is only necessary for the electric working vehicle 1 to include one inverter that drives the electric motor. That is, the electric working vehicle 1 includes at least one inverter 14Lf, 14Lr, 14Rf, or 14Rr for travel to drive the driving wheels 5Lf, 5Lr, 5Rf, and 5Rr.

The PTO system 7 provided in the electric working vehicle 1 includes the PTO shaft 7j, a motor-for-PTO 7m, and an inverter-for-PTO 7i. One end portion (first end portion) of the PTO shaft 7j is connected to the rotating shaft of the motor-for-PTO 7m via a power transmission mechanism. The other end portion (second end portion) of the PTO shaft 7j is connected to the working device 4 of the PTO support type via a universal joint. The motor-for-PTO 7m is an electric motor that rotationally drives the PTO shaft 7j. The PTO shaft 7j transmits a rotational driving force of the motor-for-PTO 7m to the working device 4 of the PTO support type. The inverter-for-PTO 7i is a drive circuit that supplies electric power from the high-voltage battery 12 to the motor-for-PTO 7m to drive the motor-for-PTO 7m.

A hydraulic system 31 provided in the electric working vehicle 1 includes the hydraulic pump 31p, a motor-for-pump 31m, and an inverter-for-pump 31i. The hydraulic system 31 includes a hydraulic fluid tank, various hydraulic devices, and a hydraulic circuit provided in the electric working vehicle 1. The hydraulic pump 31p delivers hydraulic fluid sucked from the hydraulic fluid tank to the hydraulic circuit. A hydraulic device is actuated when the hydraulic fluid delivered by the hydraulic pump 31p is supplied to the hydraulic device via the hydraulic circuit. The motor-for-pump 31m is an electric motor that drives the hydraulic pump 31p. The inverter-for-pump 31i is a drive circuit that supplies electric power from the high-voltage battery 12 to the motor-for-pump 31m to drive the motor-for-pump 31m.

The electric working vehicle 1 includes a controller 11. The controller 11 may be a vehicle control unit (VCU), an electronic control unit (ECU), or a computer including a processor 11a such as a CPU and a memory 11b. The controller 11 is configured or programmed to control the operation of each component of the electric working vehicle 1. The memory 11b is an example of a storage assembly (memory and/or storage) that stores various types of information and includes a volatile memory and a nonvolatile memory. The memory 11b stores various types of information and data for the controller 11 to control the operation of each component in a readable and writable manner. In addition to or instead of the memory 11b, the electric working vehicle 1 may include a storage assembly that is a memory drive such as a solid state drive (SSD).

The electric working vehicle 1 includes a power distribution unit (PDU) 13 and a battery management system (BMS) 15. The PDU 13 includes a switching circuit that switches the output destination of electric power. The BMS 15 is a system that monitors the state of the high-voltage battery 12. The BMS 15 includes a microcomputer 15a, a current-voltage sensor 15b, and a temperature sensor 15c. The current-voltage sensor 15b detects the voltage of the high-voltage battery 12 and the current (value of discharge current) from the high-voltage battery 12. The temperature sensor 15c detects the temperature of the high-voltage battery 12. Portions of the current-voltage sensor 15b and the temperature sensor 15c are installed in the high-voltage battery 12.

The microcomputer 15a is configured or programmed to calculate a value of discharge electric power and a state of charge (SOC) of the high-voltage battery 12 based on at least either of the voltage and the current detected by the current-voltage sensor 15b or the temperature detected by the temperature sensor 15c. Specifically, the state of charge is estimated by the microcomputer 15a using either an open circuit voltage (OCV) or a value of integrated current, or a combination of both. The microcomputer 15a is configured or programmed to transmit at least one of the voltage, the value of the discharge current, the temperature, the value of the discharge electric power, or the state of charge of the high-voltage battery 12 to the controller 11 as a value of battery indicator indicating the state of the high-voltage battery 12. When any one of the values of the battery indicator is an anomalous value exceeding a predetermined permissible range, the microcomputer 15a transmits, to the controller 11, anomaly information indicating the anomalous value and the fact that the high-voltage battery 12 is in an anomalous state.

The motors-for-travel 3Lf, 3Lr, 3Rf, and 3Rr each are a motor/generator, which is capable of operating as an electric motor or a generator to convert between electrical power and mechanical power. The motors-for-travel 3Lf, 3Lr, 3Rf, and 3Rr operate as motors to output power, and perform regenerative operation to generate electric power by rotational driving forces input from the driving wheels 5Lf, 5Lr, 5Rf, and 5Rr via the transmissions 35Lf, 35Lr, 35Rf, and 35Rr, for example, when the electric working vehicle 1 decelerates. The electric power generated by the motors-for-travel 3Lf, 3Lr, 3Rf, and 3Rr is input to the high-voltage battery 12 via the corresponding inverters 14Lf, 14Lr, 14Rf, and 14Rr and the PDU 13. That is, the high-voltage battery 12 is charged with the electric power generated by the motors-for-travel 3Lf, 3Lr, 3Rf, and 3Rr. The motor-for-PTO 7m and the motor-for-pump 31m each may be a motor/generator, and electric power generated by the motor-for-PTO 7m and the motor-for-pump 31m may be input to the high-voltage battery 12.

The controller 11 is configured or programmed to control the actuation of the PDU 13 and the inverters 14Lf, 14Lr, 14Rf, 14Rr, 7i, and 31i. The controller 11 causes the PDU 13 to switch the high-voltage battery 12 to the discharge state to supply the electric power from the high-voltage battery 12 to the inverters 14Lf, 14Lr, 14Rf, 14Rr, 7i, and 31i. The controller 11 causes the inverters-for-travel 14Lf, 14Lr, 14Rf, and 14Rr to control the motors-for-travel 3Lf, 3Lr, 3Rf, and 3Rr to rotationally drive the driving wheels 5Lf, 5Lr, 5Rf, and 5Rr.

Specifically, the controller 11 is configured or programmed to control the electric power supplied by the inverters-for-travel 14Lf, 14Lr, 14Rf, and 14Rr to the motors-for-travel 3Lf, 3Lr, 3Rf, and 3Rr, respectively to rotationally drive the driving wheels 5Lf, 5Lr, 5Rf, and 5Rr, respectively, to cause the vehicle body 2 (electric working vehicle 1) to travel. The controller 11 changes the magnitude and the supply direction of the current supplied by the inverters-for-travel 14Lf, 14Lr, 14Rf, and 14Rr to the motors-for-travel 3Lf, 3Lr, 3Rf, and 3Rr, respectively, to individually change the rotation speeds and the rotation directions of the motors-for-travel 3Lf, 3Lr, 3Rf, and 3Rr, and the driving wheels 5Lf, 5Lr, 5Rf, and 5Rr to change the vehicle speed and the direction of travel (forward travel, rearward travel, left turn, right turn) of the vehicle body 2.

Further, the controller 11 causes the inverters-for-travel 14Lf, 14Lr, 14Rf, and 14Rr to control supplying and stop supplying of the electric power to the motors-for-travel 3Lf, 3Lr, 3Rf, and 3Rr to switch the state between a two-wheel drive state in which the power is transmitted to either the front driving wheels 5Lf and 5Rf or the rear driving wheels 5Lr and 5Rr and a four-wheel drive state in which the power is transmitted to all the driving wheels 5Lf, 5Lr, 5Rf, and 5Rr.

The controller 11 causes the inverter-for-PTO 7i to control the motor-for-PTO 7m to rotationally drive the PTO shaft 7j. Specifically, the controller 11 causes the inverter-for-PTO 7i to control the electric power supplied to the motor-for-PTO 7m to rotationally drive the PTO shaft 7j. Thus, the working device 4 connected to the PTO shaft 7j is driven. More specifically, the rotor of the working device 4 of the PTO support type is rotationally driven by the power transmitted from the PTO shaft 7j, and thus the work tool connected to the rotor can perform work. The controller 11 causes the inverter-for-PTO 7i to change the magnitude and the supply direction of the current supplied to the motor-for-PTO 7m to change the rotation speeds and the rotation directions of the motor-for-PTO 7m and the rotor of the working device 4.

The controller 11 causes the inverter-for-pump 31i to control the motor-for-pump 31m to drive the hydraulic pump 31p. Specifically, the controller 11 causes the inverter-for-pump 31i to control the electric power supplied to the motor-for-pump 31m to drive the hydraulic pump 31p to cause the hydraulic fluid to be delivered from the hydraulic pump 31p. Thus, the hydraulic device can be actuated by the hydraulic fluid from the hydraulic pump 31p. The controller 11 causes the inverter-for-pump 31i to change the magnitude of the current supplied to the motor-for-pump 31m to change the rotation speed of the motor-for-pump 31m to change the delivery amount of the hydraulic fluid from the hydraulic pump 31p.

The hydraulic devices provided in the electric working vehicle 1 include the lift cylinder 6e and the control valve 36. The controller 11 inputs a control signal to the control valve 36 to switch the position and the opening of the control valve 36 to change the supply direction and the supply amount of the hydraulic fluid supplied to the lift cylinder 6e to control the actuation of extension and retraction of the lift cylinder 6e. Then, the controller 11 is configured or programmed to control the actuation of extension and retraction of the lift cylinder 6e to actuate the raising/lowering mechanism 6 to raise and lower the working device 4 connected to the raising/lowering mechanism 6.

The controller 11 causes the PDU 13 to switch the high-voltage battery 12 to the charge state to cause the electric power generated by the motors-for-travel 3Lf, 3Lr, 3Rf, and 3Rr and the like to be stored in the high-voltage battery 12. The controller 11 is configured or programmed to control charging and discharging (input/output electric power) of the high-voltage battery 12 based on the value of the indicator indicating the state of the high-voltage battery 12 detected by the BMS 15.

The electric working vehicle 1 includes a steering device 16. The steering device 16 is a device (steering system) that steers the vehicle body 2 (electric working vehicle 1), and includes a steering wheel 16a, a steering shaft 16b, a steering cylinder 16c, a control valve 16e, and a pair of left and right knuckle arms 16d. The steering wheel 16a is provided inside the cabin 9 (FIG. 1). The steering wheel 16a is also referred to as a steering handle. The steering shaft 16b rotatably supports the steering wheel 16a.

The steering cylinder 16c is an actuator for steering. The steering cylinder 16c is connected to one end portions (first end portions) of the knuckle arms 16d. The control valve 16e is, for example, a solenoid valve (electromagnetic three-position switching valve) that can be switched to any one of three positions. The other end portions (second end portions) of the knuckle arms 16d are connected to the front driving wheels 5Lf and 5Rf. The control valve 16e and the steering cylinder 16c are included in a power steering mechanism that assists steering by the steering wheel 16a. When the hydraulic fluid from the hydraulic pump 31p is supplied to the steering cylinder 16c via the control valve 16e, the steering cylinder 16c is actuated to extend and retract, the knuckle arms 16d move, and the orientation (steered angle, steering angle) of the front driving wheels 5Lf and 5Rf change.

The controller 11 inputs a control signal to the control valve 16e to change the position and the opening of the control valve 16e to change the supply direction and the supply amount of the hydraulic fluid supplied to the steering cylinder 16c to control the actuation of extension and retraction of the steering cylinder 16c. At this time, the steering shaft 16b and the steering wheel 16a are rotationally operated. Then, the controller 11 is configured or programmed to control the actuation of extension and retraction of the steering cylinder 16c to change the orientation of the front driving wheels 5Lf and 5Rf and also change the direction of travel of the vehicle body 2. When the operator seated on the operator's seat 8 rotationally operates the steering wheel 16a, the position and the opening of the control valve 16e change, the hydraulic fluid from the hydraulic pump 31p is supplied to the steering cylinder 16c via the control valve 16e, the steering cylinder 16c is actuated to extend and retract, and the orientation of the front driving wheels 5Lf and 5Rf and the direction of travel of the vehicle body 2 are changed.

The steering device 16 described above is an example, and the configuration of the steering device 16 is not limited to the configuration described above. As another example, another actuator such as a hydraulic motor, an electric cylinder, or an electric motor may be used instead of the steering cylinder 16c. Also, in the above-described example, the front wheels 5Lf and 5Rf are steered wheels, but instead of or in addition to the front driving wheels 5Lf and 5Rf, the rear driving wheels 5Lr and 5Rr may be steered wheels, and a steering device capable of changing the orientation of the steered wheels may be used. Alternatively, a steering device capable of independently changing the orientations of the plurality of steered wheels may be used.

The electric working vehicle 1 includes a braking device 17. The braking device 17 includes at least one control valve 37, at least one master cylinder 17m, a left hydraulic brake 17L, and a right hydraulic brake 17R. The at least one control valve 37 includes a plurality of (two) control valves 37 and the at least one master cylinder 17m includes a plurality of (two) master cylinders 17m provided so as to correspond to the left hydraulic brake 17L and the right hydraulic brake 17R. Hydraulic fluid is supplied to each master cylinder 17m from a reserve tank or the hydraulic pump 31p. The left hydraulic brake 17L and the right hydraulic brake 17R are disk type hydraulic brakes. The left hydraulic brake 17L brakes the rear left driving wheel 5Lr, and the right hydraulic brake 17R brakes the rear right driving wheel 5Rr.

At least one brake pedal 10d is installed inside the cabin 9. The at least one brake pedal 10d includes a plurality of (two) brake pedals 10d provided so as to correspond to the left hydraulic brake 17L and the right hydraulic brake 17R. When the operator depresses each brake pedal 10d, the corresponding master cylinder 17m is actuated, and the hydraulic fluid is supplied from the master cylinder 17m to the left hydraulic brake 17L or the right hydraulic brake 17R. Thus, the left hydraulic brake 17L or the right hydraulic brake 17R is actuated to brake the rear driving wheel 5Lr or 5Rr.

Each master cylinder 17m is also actuated by the pressure of the hydraulic fluid supplied from the hydraulic pump 31p via the corresponding control valve 37. The control valve 37 is, for example, an electromagnetic three-position switching valve. The controller 11 inputs a control signal to each control valve 37 to change the position and the opening of the control valve 37 to actuate the corresponding master cylinder 17m. The controller 11 also causes each control valve 37 to actuate the corresponding master cylinder 17m. Thus, the hydraulic fluid is supplied to the corresponding hydraulic brake 17L or 17R, the hydraulic brake 17L or 17R is actuated, and the corresponding rear driving wheel 5Lr or 5Rr is braked.

The electric working vehicle 1 includes a low-voltage battery 18 and a step-down type DC-DC converter 19. The DC-DC converter 19 steps down the voltage applied from the high-voltage battery 12 via the PDU 13. The low-voltage battery 18 stores electric power input from the high-voltage battery 12 via the PDU 13 and the DC-DC converter 19. The low-voltage battery 18 supplies electric power having a voltage lower than that of the high-voltage battery 12. The electric devices other than the electric motors 3Lf, 3Lr, 3Rf, 3Rr, 7m, and 31m provided in the electric working vehicle 1 are driven by the electric power from the low-voltage battery 18.

The electric working vehicle 1 includes an operation assembly 10. The operation assembly 10 includes a plurality of operation members (operation interfaces) operated by the operator, a plurality of sensors each of which detects the operation amount or the operation position of the corresponding operation member, and the like. The plurality of operation members include a start key 10a, an accelerator pedal 10b, a shift lever 10c, the brake pedals 10d, a parking brake lever (denoted as “PKB lever” in FIG. 2) 10e, a shuttle lever 10f, a PTO lever 10g, and the like. The plurality of operation members are installed inside the cabin 9. The steering wheel 16a may also be included in the operation assembly 10. The above-described plurality of sensors include, for example, a potentiometer, a detection switch, a limit switch, and the like.

The start key 10a includes a knob that is rotationally operated, and is operated to be turned on to activate the electric working vehicle 1 and operated to be turned off to stop driving the electric working vehicle 1. The start key 10a outputs an on signal to the controller 11 when operated to be turned on, and does not output an on signal or outputs an off signal to the controller 11 when operated to be turned off.

The accelerator pedal 10b is operated to set a target rotation speed of the motors-for-travel 3Lf, 3Lr, 3Rf, and 3Rr. The controller 11 detects the operation amount of the accelerator pedal 10b by a sensor, and determines the target rotation speed according to the operation amount. Specifically, the memory 11b stores travel control data indicating the correspondence between the operation amount of the accelerator pedal 10b and the target rotation speed of the motors-for-travel 3Lf, 3Lr, 3Rf, and 3Rr. The controller 11 determines the target rotation speed that corresponds to the operation amount of the accelerator pedal 10b based on the travel control data. Then, the controller 11 causes the inverters-for-travel 14Lf, 14Lr, 14Rf, and 14Rr to control the electric power supplied to the motors-for-travel 3Lf, 3Lr, 3Rf, and 3Rr such that the motors-for-travel 3Lf, 3Lr, 3Rf, and 3Rr rotate at the target rotation speed.

The shift lever 10c is operated to switch the speed stage of the transmissions 35Lf, 35Lr, 35Rf, and 35Rr (FIG. 3). Each of the transmissions 35Lf, 35Lr, 35Rf, and 35Rr includes a plurality of gears, a shift arm that changes the engagement state of the plurality of gears, and an actuator that operates the shift arm. The actuator is a hydraulic actuator such as a hydraulic cylinder or an electric actuator such as an electric motor. The shift lever 10c is operable to, for example, a low-speed position and a high-speed position. The controller 11 detects the operation position of the shift lever 10c by a sensor.

When the shift lever 10c is operated to the low-speed position, the controller 11 actuates the actuator of each of the transmissions 35Lf, 35Lr, 35Rf, and 35Rr via the control valve or the motor drive circuit to change the engagement of the plurality of gears by the shift arm to switch each of the transmissions 35Lf, 35Lr, 35Rf, and 35Rr to a low-speed stage. Accordingly, the power output from each of the motors-for-travel 3Lf, 3Lr, 3Rf, and 3Rr is speed-changed by the corresponding transmission 35Lf, 35Lr, 35Rf, or 35Rr, and the corresponding driving wheel 5Lf, 5Lr, 5Rf, or 5Rr rotates at a rotation speed within a predetermined first range (low-speed range).

When the shift lever 10c is operated to the high-speed position, the controller 11 actuates the actuator of each of the transmissions 35Lf, 35Lr, 35Rf, and 35Rr via the control valve or the motor drive circuit to change the engagement of the plurality of gears by the shift arm to switch each of the transmissions 35Lf, 35Lr, 35Rf, and 35Rr to a high-speed stage. Accordingly, the power output from each of the motors-for-travel 3Lf, 3Lr, 3Rf, and 3Rr is speed-changed by the corresponding transmission 35Lf, 35Lr, 35Rf, or 35Rr, and the corresponding driving wheel 5Lf, 5Lr, 5Rf, or 5Rr rotates at a rotation speed within a predetermined second range (high-speed range) which is greater than the first range. As another example, the shift lever 10c may be configured to be operable to three or more positions, and the transmissions 35Lf, 35Lr, 35Rf, and 35Rr may be configured to be switchable to any one of three or more speed stages.

The parking brake lever 10e is operated to lock the rear left driving wheel 5Lr and the rear right driving wheel 5Rr in a braked state by the left hydraulic brake 17L and the right hydraulic brake 17R. Specifically, when the parking brake lever 10e is operated by the operator, each of the brake pedals 10d is fixed in a depressed state, the corresponding hydraulic brake 17L or 17R is actuated, and the corresponding rear driving wheel 5Lr or 5Rr is braked.

The shuttle lever 10f is operated to switch the travel between forward travel and rearward travel of the vehicle body 2 (electric working vehicle 1). The shuttle lever 10f is operable to, for example, a forward travel position and a rearward travel position. The controller 11 detects the shuttle lever 10f by a sensor.

When the shuttle lever 10f is operated to the forward travel position, the controller 11 causes the inverters-for-travel 14Lf, 14Lr, 14Rf, and 14Rr to supply the current to the motors-for-travel 3Lf, 3Lr, 3Rf, and 3Rr in a first direction. Accordingly, the motors-for-travel 3Lf, 3Lr, 3Rf, and 3Rr rotate forward, the driving wheels 5Lf, 5Lr, 5Rf, and 5Rr also rotate forward, and the vehicle body 2 travels forward. In contrast, when the shuttle lever 10f is operated to the rearward travel position, the controller 11 causes the inverters-for-travel 14Lf, 14Lr, 14Rf, and 14Rr to supply the current to the motors-for-travel 3Lf, 3Lr, 3Rf, and 3Rr in a second direction. Accordingly, the motors-for-travel 3Lf, 3Lr, 3Rf, and 3Rr rotate backward, the driving wheels 5Lf, 5Lr, 5Rf, and 5Rr also rotate backward, and the vehicle body 2 travels rearward.

The PTO lever 10g is operated to set a target rotation speed of the motor-for-PTO 7m. The controller 11 detects the operation amount of the PTO lever 10g by a sensor, and determines the target rotation speed according to the operation amount. Then, the controller 11 causes the inverter-for-PTO 7i to control the electric power supplied to the motor-for-PTO 7m such that the motor-for-PTO 7m rotates at the target rotation speed.

The start key 10a, the accelerator pedal 10b, the shift lever 10c, the brake pedals 10d, the parking brake lever 10e, the shuttle lever 10f, and the PTO lever 10g are forms of an activation-stop operation interface, a travel operation interface, a speed-change operation interface, a brake operation interface, a parking brake operation interface, a forward-rearward travel operation interface, and a PTO operation interface, respectively, and the shapes thereof are not limited to a key, a pedal, and a lever. These operation interfaces 10a to 10g may have appropriate shapes such as a key, a pedal, a lever, a dial, a push button, a slider, a tumbler-switch, and a touch key.

In addition to the above, the operation assembly 10 includes various operation interfaces and the like. For example, the operation assembly 10 includes a PTO operation interface such as a PTO switch to turn on and off the PTO system 7, a lift operation interface such as a raising/lowering switch to raise and lower the working device 4 by the raising/lowering mechanism 6, a pump operation interface such as a hydraulic dial to control the delivery amount of the hydraulic fluid of the hydraulic pump 31p, and sensors that detect the operation positions or the operation amounts of these. The various operation interfaces described above are also input interfaces.

The electric working vehicle 1 includes a user interface (denoted as “UI” in FIG. 2) 20. The user interface 20 includes a touch screen, a speaker, and the like provided inside the cabin 9. The operator can input various types of information, instructions, and commands via the user interface 20. The controller 11 causes the information input via the user interface 20 to be stored in the memory 11b. The controller 11 can output various types of information to the operator by causing the user interface 20 to display the information on the display or output the information as audio from the speaker. The user interface 20 is an input interface (input device) to receive input of information, an output interface (output device) to output information, and a display device to display information.

The electric working vehicle 1 includes a steering angle sensor 21a, at least one rotation speed sensor 21b, and an inertial measurement unit (IMU) 21c. The steering angle sensor 21a detects a turning angle of the steering wheel 16a (i.e., steering angle). More specifically, the steering angle sensor 21a is a sensor that detects the angle of rotation of the steering shaft 16b that rotates according to the rotation operation of the steering wheel 16a. The controller 11 determines that the angle of rotation detected by the steering angle sensor 21a is the turning angle of the steering wheel 16a (i.e., steering angle) and the steered angle of the front driving wheels 5Lf and 5Rf. The controller 11 determines the direction of travel and the steering direction of the vehicle body 2 based on the steering angle detected by the steering angle sensor 21a.

The at least one rotation speed sensor 21b includes a plurality of rotation speed sensors 21b so as to correspond to the motors-for-travel 3Lf, 3Rf, 3Lr, and 3Rr on a one-to-one basis. The rotation speed sensors 21b detect the rotation speeds of the motors-for-travel 3Lf, 3Rf, 3Lr, and 3Rr. The controller 11 causes the inverters-for-travel 14Lf, 14Rf, 14Lr, and 14Rr to control the electric power supplied to the motors-for-travel 3Lf, 3Rf, 3Lr, and 3Rr, respectively, based on the rotation speeds of the motors-for-travel 3Lf, 3Rf, 3Lr, and 3Rr detected by the rotation speed sensors 21b.

For example, the controller 11 is configured or programmed to control (feedback control or the like) the electric power supplied to the motors-for-travel 3Lf, 3Rf, 3Lr, and 3Rr such that the motors-for-travel 3Lf, 3Rf, 3Lr, and 3Rr rotate at the target rotation speed based on the rotation speeds of the motors-for-travel 3Lf, 3Rf, 3Lr, and 3Rr detected by the rotation speed sensors 21b. The controller 11 may calculate the vehicle speed of the vehicle body 2 based on the rotation speeds of the motors-for-travel 3Lf, 3Rf, 3Lr, and 3Rr detected by the rotation speed sensors 21b.

The rotation speed sensors 21b may be provided so as to correspond to the motor-for-PTO 7m and the motor-for-pump 31m in a one to-one basis. Then, the rotation speed sensors 21b may detect the rotation speed of the motor-for-PTO 7m and the rotation speed of the motor-for-pump 31m. In this case, the controller 11 may cause the inverter-for-PTO 7i to control the electric power supplied to the motor-for-PTO 7m based on the rotation speed of the motor-for-PTO 7m detected by the rotation speed sensor 21b. The controller 11 may cause the inverter-for-pump 31i to control the electric power supplied to the motor-for-pump 31m based on the rotation speed of the motor-for-pump 31m detected by the rotation speed sensor 21b.

The IMU 21c detects three-dimensional inertial motion (translational motion and rotational motion in three orthogonal-axis directions) of the vehicle body 2. Specifically, the IMU 21c detects the roll angle, the pitch angle, the yaw angle, the accelerations in three orthogonal-axis directions, and the like of the vehicle body 2. The roll angle detected by the IMU 21c is an inclination angle of the vehicle body 2 with respect to the direction of roll, and can be regarded as an angle of slope of the ground surface (the ground surface on which the electric working vehicle 1 travels) with respect to the direction of roll. The IMU 21c is an example of a sloping-angle sensor.

The controller 11 acquires the angle of slope of a ground surface with respect to the direction of roll of the vehicle body 2 from the detection result of the IMU 21c. The controller 11 calculates the speed and the azimuth (orientation, direction of travel) of the vehicle body 2 based on the detection result of the IMU 21c. Instead of or in addition to the IMU 21c, the electric working vehicle 1 may include other sloping-angle sensors such as a gyroscope sensor, an acceleration sensor, and an angular speed sensor.

The electric working vehicle 1 includes a laser sensor 22a of, for example, light detection and ranging or laser imaging detection and ranging (LiDAR), and a camera 22c. The laser sensor 22a and the camera 22c are installed at appropriate positions such as a front portion, a rear portion, left and right side portions, an upper portion, and a lower portion of the electric working vehicle 1, and detect the state of the surrounding environment of the electric working vehicle 1 and the working device 4.

The laser sensor 22a detects an object existing within the range at a predetermined distance from the electric working vehicle 1, and measures the distance to the object by time of flight (TOF). The camera 22c includes an image sensor such as a charge coupled device (CCD) or a complementary metal oxide semiconductor (CMOS). The camera 22c captures images of the surrounding area such as the front area, the rear area, the left area, and the right area of the electric working vehicle 1. The controller 11 detects an object present in the surrounding area of the electric working vehicle 1 (in the image-capturing range of the camera 22c) based on at least one of the detection result of the laser sensor 22a or the captured image captured by the camera 22c. The object includes not only a predetermined obstacle that obstructs the travel of the electric working vehicle 1, but also other objects such as the ground surface Hs (including the road surface) on which the electric working vehicle 1 travels, and the working device 4 connected to the vehicle body 2. The laser sensor 22a and the camera 22c are also sensors that detect the working device 4 connected to the vehicle body 2. The laser sensor 22a and the camera 22c are also input interfaces.

The controller 11 may determine whether the working device 4 is connected to the vehicle body 2 based on at least one of the detection result of the laser sensor 22a or the captured image of the camera 22c. The controller 11 may determine the type of the working device 4 connected to the vehicle body 2 based on the captured image of the camera 22c that captures an image of the rear area of the electric working vehicle 1.

Specifically, the controller 11 extracts an image of the working device 4 from, for example, the captured image of the rear area of the vehicle body 2 captured by the camera 22c, and compares the image of the working device 4 with images of various working devices stored in advance in the memory 11b to determine the type such as the directly mounted type, the towed type, the PTO support type, the raised/lowered type, the ground contact type, or the noncontact type as the type of the working device 4. The controller 11 determines the model name (cultivator, spreader, . . . , harvester, or the like) of the working device 4 from the comparison result, and further determines work or the like that can be performed by the working device 4 based on the model name. The captured image of the camera 22c obtained by capturing the image of the rear area of the electric working vehicle 1 is an example of device information relating to the working device 4 connected to the vehicle body 2.

The controller 11 may determine at least one of the geographic feature or the size of the place where the electric working vehicle 1 is located based on at least one of the detection result of the laser sensor 22a or the captured image of the camera 22c. For example, the controller 11 may calculate whether the ground surface Hs on which the vehicle body 2 travels has a slope based on at least one of the detection result of the laser sensor 22a or the captured image of the camera 22c. The controller 11 may calculate the angle of slope of the ground surface Hs with respect to the direction of roll of the vehicle body 2 based on at least one of the detection result of the laser sensor 22a or the captured image of the camera 22c. Further, the controller 11 may determine that the calculated angle of slope of the ground surface Hs is the roll angle of the vehicle body 2. The laser sensor 22a and the camera 22c are examples of the sloping-angle sensor.

The electric working vehicle 1 includes a position detector 23. The position detector 23 is mounted on the vehicle body 2 and detects the position thereof (measured position information including latitude and longitude) by a positioning satellite system. Specifically, the position detector 23 includes a global navigation satellite system (GNSS) receiver that receives signals (positions of positioning satellites, transmission times, correction information, and the like) transmitted from positioning satellites, and detects the position thereof based on the signals received by the GNSS receiver. The controller 11 determines that the position detected by the position detector 23 is the position of the vehicle body 2 (electric working vehicle 1). That is, the position detector 23 detects the position of the vehicle body 2 by the positioning satellite system. The controller 11 may calculate the vehicle speed and the azimuth of the vehicle body 2 based on the time-series position data of the vehicle body 2 detected by the position detector 23.

The electric working vehicle 1 includes a communication device 24. The communication device 24 is a communication interface to communicate with at least one of the working device 4, a server 41, a terminal device 42, or a remote device 43, and is an input interface and an output interface. The communication device 24 includes a wired communication port 24a, a short-range communication module 24b, and a wide-area communication module 24c. Note that, at least one of the wired communication port 24a, the short-range communication module 24b, or the wide-area communication module 24c may be included in the communication device 24.

The wired communication port 24a is a port to communicate with an electronic control unit such as a CPU or another electronic device mounted on the working device 4 in a wired manner. When the electronic control unit of the working device 4 is connected to the wired communication port 24a via an electric cable, the controller 11 can communicate with the electronic control unit. When another electronic device (such as a computer or a storage medium) is connected to the wired communication port 24a via an electric cable, the controller 11 can communicate with the electronic device.

The short-range communication module 24b is a wireless communication module that transmits and receives a radio signal conforming to a short-range wireless communication standard such as Bluetooth (registered trademark) Low Energy. When a wireless communication module and an electronic control unit that conform to the short-range wireless communication standard are mounted on the working device 4 connected to the vehicle body 2, the electronic control unit and the controller 11 communicate wirelessly with each other via the wireless communication module and the short-range communication module 24b to transmit and receive information.

The wide-area communication module 24c is a wireless communication module that communicates via a wide area network such as a cellular phone communication network and the Internet. The controller 11 communicates wirelessly with external devices such as the server 41, the terminal device 42, and the remote device 43 via the wide-area communication module 24c to transmit and receive information.

The server 41, the terminal device 42, and the remote device 43 are examples of an external device provided outside the electric working vehicle 1. The server 41 is a computer provided in a management center or a cloud system. The terminal device 42 is a portable or stationary computer. The terminal device 42 includes a user interface, and various types of information can be input and output via the user interface.

The remote device 43 is a device for an operator at a remote location to remotely operate the electric working vehicle 1. The remote device 43 includes an operation assembly that remotely operates the electric working vehicle 1, and a user interface. The operation assembly of the remote device 43 includes a configuration equivalent to that of the operation assembly 10 of the electric working vehicle 1.

When the operator operates the operation assembly of the remote device 43, a remote operation signal corresponding to the operation is transmitted from the remote device 43 to the electric working vehicle 1. When the controller 11 receives the remote operation signal via the wide-area communication module 24c of the communication device 24, the controller 11 is configured or programmed to control the motors-for-travel 3Lf, 3Rf, 3Lr, and 3Rr, the steering device 16, and the like based on the remote operation signal to perform automatic travel to cause the electric working vehicle 1 to automatically travel or cause the working device 4 to perform work.

The operator or the like of the electric working vehicle 1 inputs device information relating to the working device 4 connected to the electric working vehicle 1 via the user interface 20. Alternatively, the device information is input (received) from the electronic control unit or the like (including another electronic device) of the working device 4 connected to the electric working vehicle 1 via the wired communication port 24a of the communication device 24 or via the short-range communication module 24b. Alternatively, the operator inputs device information relating to the working device 4 connected to the electric working vehicle 1 via the user interface of the terminal device 42, and the device information is transmitted from the terminal device 42 and input (received) via the wide-area communication module 24c of the communication device 24.

The device information input to the electric working vehicle 1 via the user interface 20 or the communication device 24 as described above may include information indicating the type of the working device 4 connected to the electric working vehicle 1. In this case, the controller 11 receives the input device information and determines the type of the working device 4 connected to the electric working vehicle 1 based on the device information.

The memory 11b of the controller 11 stores a plurality of pieces of identification information of a plurality of working devices 4 that can be used for the electric working vehicle 1, and a plurality of pieces of candidate device information indicating the types and the like (specifications may be included) of the plurality of working devices 4 in an associated manner. When the device information input to the electric working vehicle 1 via the user interface 20 or the communication device 24 includes the identification information of the working device 4 connected to the electric working vehicle 1, the controller 11 extracts the identification information of the working device 4 from the input device information. Then, the controller 11 reads (receives) the candidate device information corresponding to the extracted identification information from the memory 11b, and determines the type of the working device 4 connected to the vehicle body 2 from the read candidate device information. The controller 11 may determine the model name, the specifications, and the like of the working device 4 connected to the vehicle body 2 from the read candidate device information.

The controller 11 may determine the type of the working device 4 from the operation amount or the operation position of the operation interface included in the operation assembly 10. For example, when the PTO lever 10g is operated to a predetermined position or when the PTO switch is turned to the on position, a signal indicating the operation position (device information relating to the working device 4) is output from the corresponding sensor. The controller 11 may determine that the type of the working device 4 is the PTO support type based on the output signal. When the raising/lowering switch is operated by a predetermined amount, a signal indicating the operation amount (device information) is output from the corresponding sensor. The controller 11 may determine that the type of the working device 4 is the raised/lowered type and the ground contact type based on the output signal.

The memory 11b of the controller 11 stores vehicle information relating to the electric working vehicle 1 and a work plan for the electric working vehicle 1 (vehicle body 2) to travel and the working device 4 to perform work in an agricultural field. The vehicle information includes the identification information, the type, and the specifications of the electric working vehicle 1, the specifications of a device provided in the electric working vehicle 1, and the like. The work plan includes information indicating the type of work to be performed, agricultural field information relating to an agricultural field where the work is performed, route information indicating a planned travel route for the electric working vehicle 1 to travel to perform the work in the agricultural field, and the like.

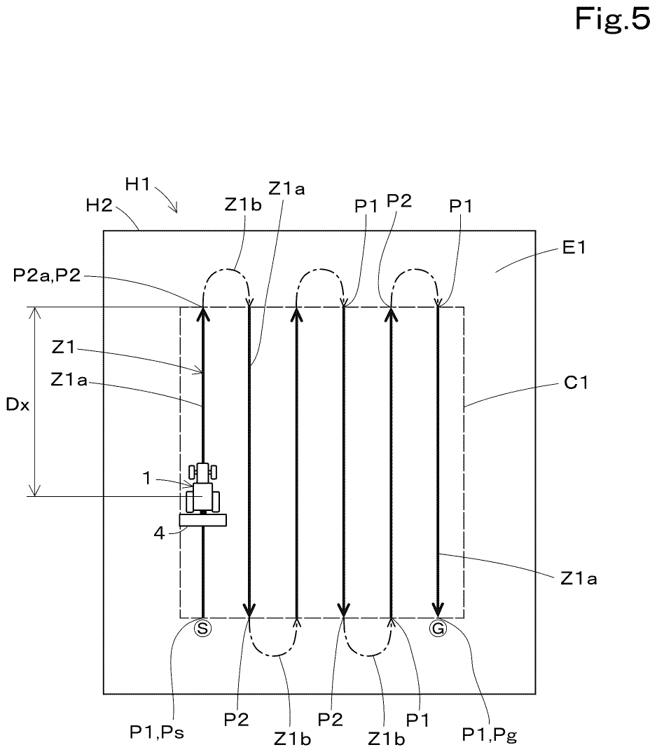

FIG. 5 is a diagram illustrating an example of a planned travel route for the electric working vehicle 1. A work area C1 is set at the center of an agricultural field H1 illustrated in FIG. 5, and a headland E1 is set around the work area C1. The agricultural field information included in the work plan includes information indicating the position, the area, and the contour H2 of the agricultural field H1, and information indicating the positions of the work area C1 and the headland E1. A planned travel route Z1 for the electric working vehicle 1 in the agricultural field H1 includes a plurality of straight portions Z1a (thick solid line arrows in FIG. 5) set in the work area C1 and a plurality of turn portions Z1b (thin one-dot chain line arrows in FIG. 5) set in the headland E1.

The straight portions Z1a each are a work route for the vehicle body 2 to travel straight and for the working device 4 to perform work. The turn portions Z1b each are a route serving as a guide for the vehicle body 2 to turn (change the direction) from an end point (an arrow tip portion of the thick solid line arrow) P2 of one straight portion Z1a toward a start point (a proximal portion of the thick solid line arrow) P1 of the next straight portion Z1a without work performed by the working device 4. A start point P1 of a straight portion Z1a where the work is performed first is a start point Ps of the planned travel route Z1. An end point P2 of a straight portion Z1a where the work is performed last is a goal point Pg of the planned travel route Z1 and is a completion point of the work.

The route information included in the work plan includes information indicating the positions of the start point Ps, the straight portions Z1a, the turn portions Z1b, and the goal point Pg of the planned travel route Z1. The route information may include information indicating the distance of the straight portions Z1a, the vehicle speed when the working device 4 performs work while the vehicle body 2 travels along the straight portions Z1a, and the like. Alternatively, the controller 11 may calculate the distance of the straight portions Z1a from the positions of the straight portions Z1a included in the route information.

The memory 11b may store map information relating to a region where the electric working vehicle 1 travels. The region indicated by the map information may include an agricultural field and an area other than the agricultural field. The map information may include information indicating the geographic feature, the position, and the like of the region.

At least one of the candidate device information, the vehicle information, the work plan, or the map information may be input via the user interface 20 and stored in the memory 11b by the controller 11. Alternatively, the operator may input at least one of the candidate device information, the vehicle information, the work plan, or the map information via the user interface of the terminal device 42, and the input information may be transmitted from the terminal device 42 to the electric working vehicle 1. Then, when at least one of the candidate device information, the vehicle information, the work plan, or the map information is received (input) via the wide-area communication module 24c, the controller 11 may cause the received information to be stored in the memory 11b.

Alternatively, at least one of the candidate device information, the vehicle information, the work plan, or the map information may be stored in the database of the server 41. Then, the controller 11 may communicate with the server 41 via the wide-area communication module 24c of the communication device 24, receive at least one of the candidate device information, the vehicle information, the work plan, or the map information, and cause the received information to be stored in the memory 11b.

The controller 11 generates status information indicating the state of the electric working vehicle 1, and transmits the status information to an external device, which is at least one of the server 41, the terminal device 42, or the remote device 43, via the wide-area communication module 24c of the communication device 24. When the server 41 receives the status information from the electric working vehicle 1, the server 41 stores the status information in the database. The server 41 may transfer the status information received from the electric working vehicle 1 to the terminal device 42. When receiving the status information from the electric working vehicle 1, at least one of the terminal device 42 or the remote device 43 may output (display) the status information via the user interface.

The controller 11 performs work-and-travel in which the controller 11 causes the motors-for-travel 3Lf, 3Rf, 3Lr, and 3Rr to drive the driving wheels 5Lf, 5Rf, 5Lr, and 5Rr to cause the vehicle body 2 to travel and causes the working device 4 connected to the vehicle body 2 to perform work. At this time, the controller 11 is configured or programmed to control at least one of the actuator of the motor-for-PTO 7m or the actuator of the lift cylinder 6e according to the type of the working device 4 to cause the working device 4 perform work.

For example, when the type of the working device 4 is the PTO support type, the controller 11 causes the inverter-for-PTO 7i to drive the motor-for-PTO 7m to rotationally drive the PTO shaft 7j to drive the working device 4 by the rotational driving force of the PTO shaft 7j to perform work. When the type of the working device 4 is the raised/lowered type and the ground contact type, the controller 11 causes the lift cylinder 6e (raising/lowering mechanism 6) to lower the working device 4 to bring at least the work tool of the working device 4 into contact with the ground surface to perform work.

When the type of the working device 4 is the PTO support type, the raised/lowered type, and the ground contact type, the controller 11 is configured or programmed to control the motor-for-PTO 7m and the lift cylinder 6e as described above to bring the work tool of the working device 4 into contact with the ground surface and drive the working device 4 by the rotational driving force of the PTO shaft 7j to perform work. Even when the type of the working device 4 is another type (a third working device of, for example, a working device of the towed type and the non-driven work type) which differs from the PTO support type, the raised/lowered type, and the ground contact type, the controller 11 does not control the motor-for-PTO 7m and the lift cylinder 6e, and moves the working device 4 by the propelling power of the electric working vehicle 1 to perform work.

The controller 11 causes the inverters-for-travel 14Lf, 14Rf, 14Lr, and 14Rr to limit the electric power supplied to at least one of the motor-for-travel 3Lf, 3Rf, 3Lr, or 3Rr. Accordingly, the output from the at least one of the motor-for-travel 3Lf, 3Rf, 3Lr, or 3Rr is also limited. That is, the controller 11 causes the inverters-for-travel 14Lf, 14Rf, 14Lr, and 14Rr to limit the output of at least one of the motor-for-travel 3Lf, 3Rf, 3Lr, or 3Rr. Additionally or alternatively, the controller 11 limits the electric power supplied to any of the motors-for-travel 3Lf, 3Lr, 3Rf, and 3Rr according to the state of charge of the high-voltage battery 12 detected by the BMS 15, for example.

The controller 11 causes the working device 4 to stop performing the work according to the state of charge of the high-voltage battery 12 and the type of the working device 4. At this time, the controller 11 is configured or programmed to control one of the motor-for-PTO 7m or the lift cylinder 6e based on the type of the working device 4 to cause the working device 4 to stop performing the work. Additionally or alternatively, the controller 11 is configured or programmed to control at least one of the motor-for-PTO 7m or the lift cylinder 6e, and the motors-for-travel 3Lf, 3Lr, 3Rf, and 3Rr according to the state of charge of the high-voltage battery 12 and the type of the working device 4 to cause the working device 4 to stop performing the work and to cause the vehicle body 2 to stop traveling.

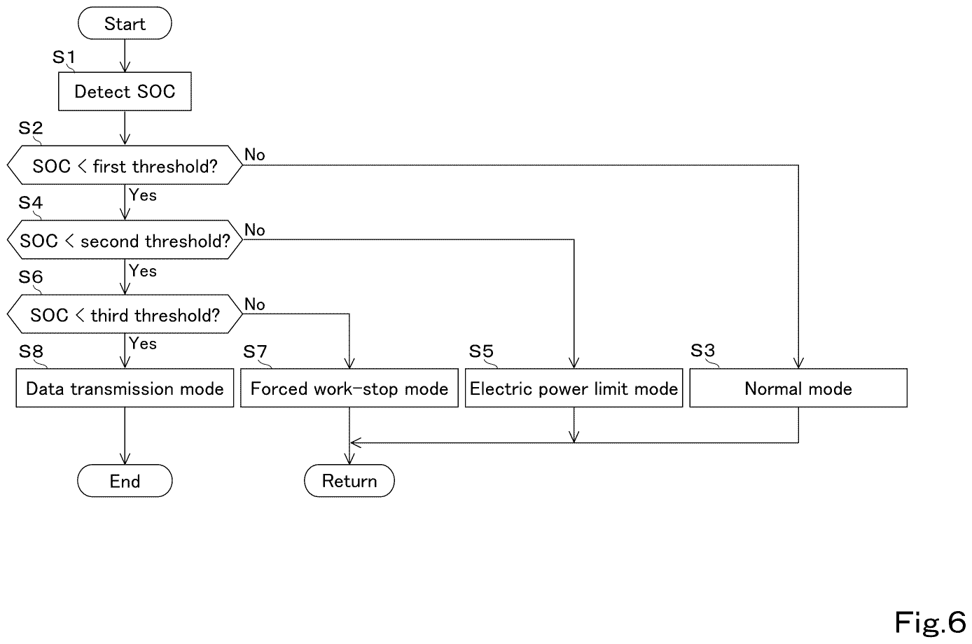

FIG. 6 is a flowchart presenting an example of an operation of the electric working vehicle 1. Each step in FIG. 6 is performed by the controller 11 (processor 11a) according to a software program stored in the memory 11b. Each step of another flowchart described later is performed similarly.

When the electric working vehicle 1 is activated, the controller 11 detects the state of charge (current SOC) of the high-voltage battery 12 by the BMS 15 (S1). When the state of charge of the high-voltage battery 12 is equal to or greater than a first threshold (S2: NO), the controller 11 transitions to a normal mode (S3). The normal mode is a mode in which at least one of travel of the electric working vehicle 1 or work by the working device 4 is performed without limiting the electric power supplied from the high-voltage battery 12 to the motors-for-travel 3Lf, 3Rf, 3Lr, and 3Rr, the motor-for-PTO 7m, and the motor-for-pump 31m. In the normal mode, the electric working vehicle 1 performs work-and-travel (normal work-and-travel) manually or automatically without limiting the output of each of the electric motors 3Lf, 3Rf, 3Lr, 3Rr, 7m, and 31m.

Specifically, when the electric working vehicle 1 is in the normal mode and is manually operated, the controller 11 causes the inverters-for-travel 14Lf, 14Rf, 14Lr, and 14Rr to control the electric power supplied to the motors-for-travel 3Lf, 3Rf, 3Lr, and 3Rr such that the motors-for-travel 3Lf, 3Rf, 3Lr, and 3Rr rotate at the target rotation speed corresponding to the operation amount of the accelerator pedal 10b. In contrast, when the electric working vehicle 1 is in the normal mode and is automatically operated, the controller 11 causes the inverters-for-travel 14Lf, 14Rf, 14Lr, and 14Rr to control the electric power supplied to the motors-for-travel 3Lf, 3Rf, 3Lr, and 3Rr such that the motors-for-travel 3Lf, 3Rf, 3Lr, and 3Rr rotate at the target rotation speed corresponding to the vehicle speed defined by the route information included in the work plan or the target rotation speed indicated by the remote operation signal from the remote device 43.

When the electric working vehicle 1 is in the normal mode, the controller 11 adjusts the target rotation speed of the motors-for-travel 3Lf, 3Rf, 3Lr, and 3Rr according to the turning angle of the steering wheel 16a (i.e., steering angle). The controller 11 causes the inverter-for-PTO 7i to control the electric power supplied to the motor-for-PTO 7m such that the motor-for-PTO 7m rotates at the PTO target rotation speed corresponding to the operation amount of the PTO lever 10g, the PTO target rotation speed defined by the work plan (route information), or the PTO target rotation speed indicated by the remote operation signal. The controller 11 causes the inverter-for-pump 31i to control the electric power supplied to the motor-for-pump 31m such that the motor-for-pump 31m rotates at the target rotation speed corresponding to the operation amount of the hydraulic dial, the rotation speed for pump defined in the work plan, or the rotation speed for pump indicated by the remote operation signal.

That is, in the normal mode, the controller 11 causes the electric motors 3Lf, 3Rf, 3Lr, 3Rr, 7m, and 31m to rotate at the rotation speeds instructed or defined by any one of the operation assembly 10, the work plan, or the remote operation signals to perform work-and-travel. After the transition to the normal mode (S3 in FIG. 6), the controller 11 repeats step S1 and subsequent steps.

When the state of charge of the high-voltage battery 12 is less than the first threshold (S2: YES) and the state of charge is equal to or greater than a second threshold (S4: NO), the controller 11 transitions to an electric power limit mode (S5). At this time, when the controller 11 is already in the normal mode, the controller 11 stops the normal mode and transitions to the electric power limit mode. The second threshold is set to a value which is less than the first threshold. The electric power limit mode is a mode in which the electric power supplied from the high-voltage battery 12 to the motors-for-travel 3Lf, 3Rf, 3Lr, and 3Rr is limited. In the electric power limit mode, the controller 11 performs the work-and-travel manually or automatically while limiting the electric power supplied by the inverters-for-travel 14Lf, 14Rf, 14Lr, and 14Rr to the motors-for-travel 3Lf, 3Rf, 3Lr, and 3Rr.

That is, the controller 11 limits (reduces) the electric power supplied to the motors-for-travel 3Lf, 3Rf, 3Lr, and 3Rr to limit (reduce) the maximum output of the motors-for-travel when the work-and-travel is performed according to an operation of a predetermined operation interface such as the accelerator pedal 10b or the user interface 20, or the remote operation signal received by the communication device 24, and during the work-and-travel.

More specifically, the controller 11 limits (reduces) the electric power supplied to at least one of the motor-for-travel 3Lf, 3Rf, 3Lr, or 3Rr such that, for example, the value of the discharge electric power from the high-voltage battery 12 detected by the BMS 15 is equal to or less than the upper limit. As another example, the controller 11 may limit (reduce) the electric power supplied to at least one of the motor-for-travel 3Lf, 3Rf, 3Lr, or 3Rr by a certain ratio. After the transition to the electric power limit mode (step S5 in FIG. 6), the controller 11 repeats step S1 and subsequent steps.

When the state of charge of the high-voltage battery 12 is less than the second threshold (S4: YES) and the state of charge is equal to or greater than a third threshold (S6: NO), the controller 11 transitions to a forced work-stop mode (S7). The third threshold is set to a value which is less than the second threshold. The forced work-stop mode is a mode in which work by the working device 4 is forcibly stopped. In the forced work-stop mode, the electric working vehicle 1 (controller 11) performs a travel-without-work in which the electric working vehicle 1 (controller 11) causes the vehicle body 2 to travel while causing the working device 4 to not perform work. Note that, when the electric working vehicle 1 transitions to the forced work-stop mode (S7), in a case where the electric working vehicle 1 is already in the electric power limit mode, the electric power limit mode is continued. After the transition to the forced work-stop mode (step S7 in FIG. 6), the controller 11 repeats step S1 and subsequent steps.

When the state of charge of the high-voltage battery 12 is less than the third threshold (S6: YES), the controller 11 transitions to data transmission mode (S8). When the controller 11 transitions to the data transmission mode, the controller 11 generates status information of the electric working vehicle 1, and transmits the status information to an external device, which is at least one of the server 41, the terminal device 42, or the remote device 43, via the communication device 24 (wide-area communication module 24c). The server 41 receives the status information and stores (records) the status information in the database. The terminal device 42 and the remote device 43 receive the status information and output (display) the status information via the user interface. When the electric working vehicle 1 transitions to the data transmission mode (S8), in a case where the electric working vehicle 1 is already in at least one of the electric power limit mode or the forced work-stop mode, the mode is continued.

The controller 11 adds, to the status information, for example, at least one of the position of the vehicle body 2, the orientation of the vehicle body 2, the traveled route (track) traveled by the vehicle body 2, or the device information of the working device 4, and the identification information of the electric working vehicle 1. The status information transmitted by the controller 11 in the data transmission mode is information immediately before power stop indicating the state of the electric working vehicle 1 immediately before the electric power stored in the high-voltage battery 12 is completely used.

The first threshold to be compared to the state of charge of the high-voltage battery 12 may be a fixed value defined in advance or may be a variable value set as appropriate. For example, when the controller 11 performs a work plan stored in the memory 11b in response to an instruction to perform the work plan input from the user interface 20 or the remote device 43 via the communication device 24, the controller 11 determines the first threshold based on the work plan. The controller 11 determines that it is the timing to perform (when to perform) the work plan when an instruction to perform the work plan is input via the user interface 20, or when the instruction is transmitted from the terminal device 42 or the remote device 43 and received (input) via the communication device 24. Alternatively, the controller 11 determines that it is the timing to perform the work plan when the position of the vehicle body 2 detected by the position detector 23 is detected to be in the agricultural field H1 indicated by the work plan.

Then, at the timing to perform(when to perform) the work plan, the controller 11 calculates an estimated travel distance to be traveled by the electric working vehicle 1 based on the planned travel route Z1 (FIG. 5) included in the work plan. That is, the controller 11 calculates the estimated travel distance when the electric working vehicle 1 travels along the planned travel route Z1. Then, the controller 11 determines the first threshold based on the estimated travel distance.

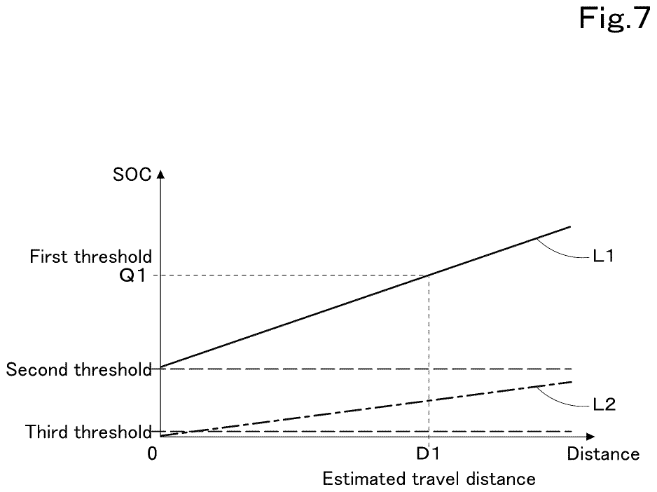

FIG. 7 is a diagram (graph) presenting an example of the relationship between the estimated travel distance to be traveled by the electric working vehicle 1 and the threshold. In the graph presented in FIG. 7, the horizontal axis represents the distance, and the vertical axis represents the state of charge (SOC). A line L1 indicated by a thick solid line in FIG. 7 indicates the correspondence between the estimated travel distance and the first threshold. Control data (first control data) exhibiting the line L1 is stored in the memory 11b in the form of a linear function, a table, or the like. The controller 11 determines a state of charge Q1 corresponding to an estimated travel distance D1 calculated based on a planned travel route Z1 from the control data of the line L1, and determines that the state of charge Q1 is the first threshold. In the control data of the line L1, the first threshold is defined to increase as the estimated travel distance increases.

A line L2 indicated by a one-dot chain line in FIG. 7 indicates the correspondence between the estimated travel distance and the required state of charge. The required state of charge is a state of charge of the high-voltage battery 12 required for the electric working vehicle 1 to travel the estimated travel distance. As indicated by the line L2, the required state of charge increases as the estimated travel distance increases. The first threshold (SOC) indicated by the line L1 is defined as a value which is greater than the required state of charge indicated by the line L2. The first threshold is defined such that, the difference between the first threshold (SOC) indicated by the line L1 and the required state of charge indicated by the line L2 increases as the estimated travel distance increases. Thus, the controller 11 determines the first threshold such that the difference between the first threshold and the required state of charge increases as the estimated travel distance increases.

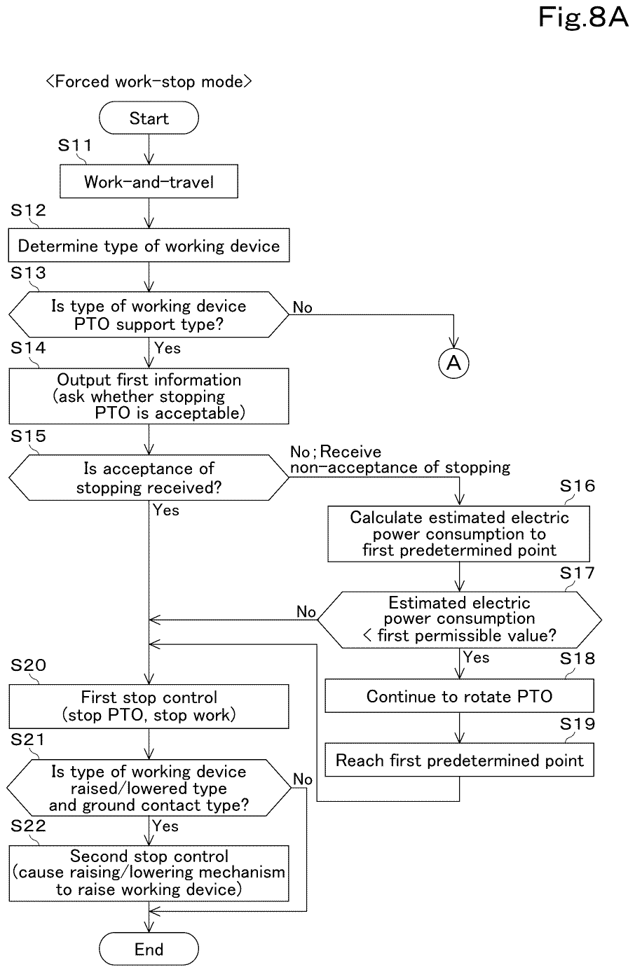

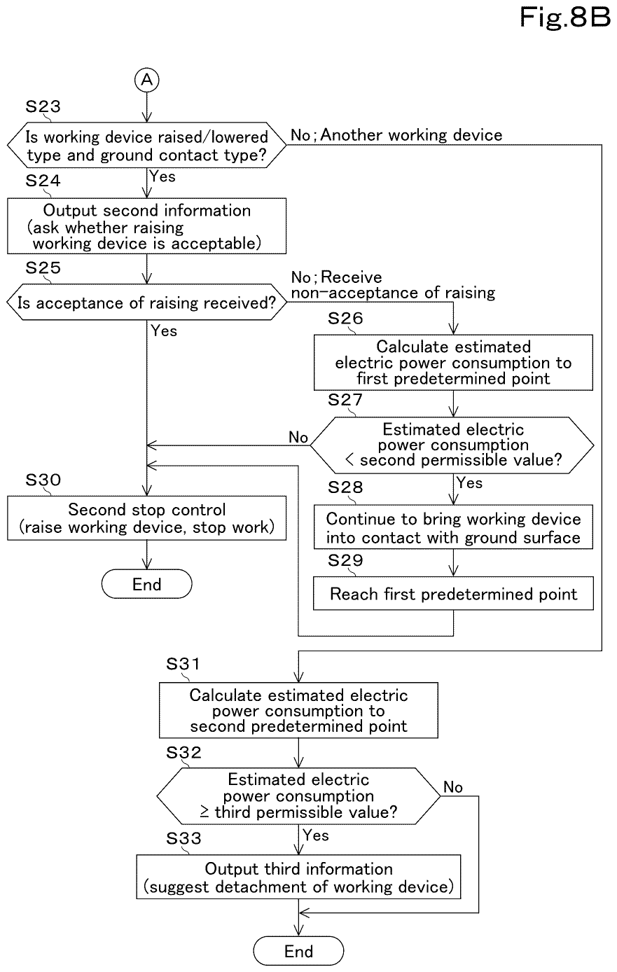

FIGS. 8A and 8B are flowcharts presenting an example of an operation of the electric working vehicle 1 in the forced work-stop mode. In the forced work-stop mode, while causing the electric working vehicle 1 to perform the work-and-travel by automatic operation or manual operation in the agricultural field H1 (S11 in FIG. 8A), the controller 11 determines the type of the working device 4 connected to the vehicle body 2 based on the device information relating to the working device 4 (S12).

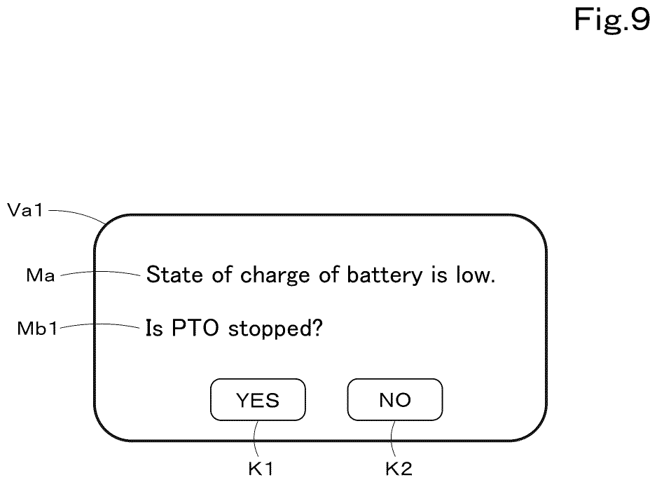

When determining that the type of the working device 4 is the PTO support type (first working device) (S13: YES), the controller 11 causes the user interface 20 to output first information asking whether stopping the PTO shaft 7j is acceptable or not (S14). At this time, the controller 11 causes a touch screen included in the user interface 20 to display, for example, first information Va1 as illustrated in FIG. 9.

The first information Va1 includes information Ma indicating that the state of charge of the high-voltage battery 12 is low and information Mb1 asking whether stopping the PTO shaft 7j is acceptable or not in the form of messages. The first information Va1 includes a YES key K1 and a NO key K2.

When the operator (user, driver) operates (touches) the YES key K1 included in the first information Va1, the controller 11 determines that an instruction to accept stopping the PTO shaft 7j is received (S15 in FIG. 8A: YES), and performs a first stop control (S20).

In the first stop control, the controller 11 causes the inverter-for-PTO 7i to stop the electric power from being supplied to the motor-for-PTO 7m to stop rotationally driving the PTO shaft 7j. Accordingly, the driving of the rotor of the working device 4 connected to the PTO shaft 7j is stopped, and the work by the working device 4 is stopped. At this time, the controller 11 causes the inverters-for-travel 14Lf, 14Rf, 14Lr, and 14Rr to continue to supply the electric power to the motors-for-travel 3Lf, 3Rf, 3Lr, and 3Rr. Thus, the electric working vehicle 1 continues to travel while causing the working device 4 to stop performing the work. That is, the controller 11 performs the travel-without-work in which the controller 11 causes the vehicle body 2 to travel while causing the working device 4 to stop performing the work.

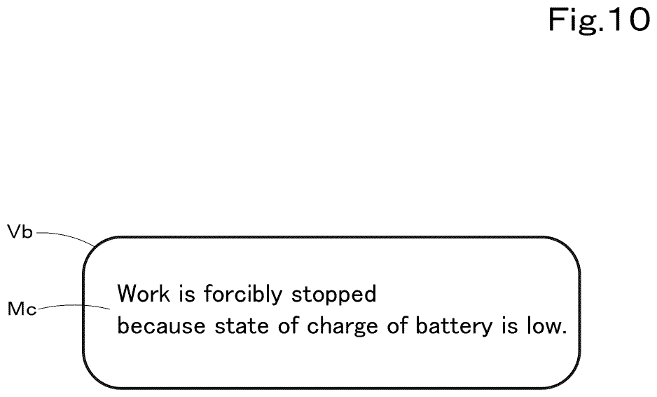

The controller 11 may perform the first stop control after a predetermined time elapses since the position of the vehicle body 2 reaches a first predetermined point such that the rotational driving of the PTO shaft 7j is stopped and the work by the working device 4 is stopped when the working device 4 reaches the first predetermined point. When performing the first stop control (S20), the controller 11 may cause the user interface 20 to output, for example, stop information Vb indicating that the work is forcibly stopped as illustrated in FIG. 10. The stop information Vb includes information Mc indicating that the work is forcibly stopped because the state of charge of the high-voltage battery 12 is low in the form of messages. When performing the first stop control, the controller 11 may add, to the stop information Vb, at least one of information indicating that the PTO shaft 7j is stopped or information indicating that the travel of the electric working vehicle 1 is not stopped.

When the operator operates the NO key K2 included in the first information Va1 (FIG. 9), the controller 11 determines that an instruction to not accept stopping the PTO shaft 7j is received (S15 in FIG. 8A: NO). Then, the controller 11 calculates estimated electric power consumption which is an electric power estimated to be consumed by the electric working vehicle 1 if the work-and-travel of the electric working vehicle 1 is (assumed to be) continued until the vehicle body 2 reaches the first predetermined point (S16). At this time, the controller 11 calculates estimated electric power consumption corresponding to the working device of the PTO support type. That is, the controller 11 calculates estimated electric power consumption which is an electric power estimated to be consumed by the electric working vehicle 1 if the work-and-travel of the electric working vehicle 1 is continued while the PTO shaft 7j is rotationally driven until the vehicle body 2 reaches the first predetermined point.

Specifically, the controller 11 determines that the first predetermined point is one end point P2a of, for example, the end points P2 of the plurality of straight portions Z1a included in the planned travel route Z1 (FIG. 5) of the agricultural field H1 stored in the memory 11b that is present in a direction of travel of the vehicle body 2 of the electric working vehicle 1 and that is closest from the position of the vehicle body 2. Then, the controller 11 calculates an estimated travel distance Dx to be traveled by the electric working vehicle 1 from the position of the vehicle body 2 to the first predetermined point P2a based on the position (current position) of the vehicle body 2 detected by the position detector 23 and the planned travel route Z1. As another example, the controller 11 may determine that the first predetermined point is the goal point Pg of the planned travel route Z1 or another point in the agricultural field H1.

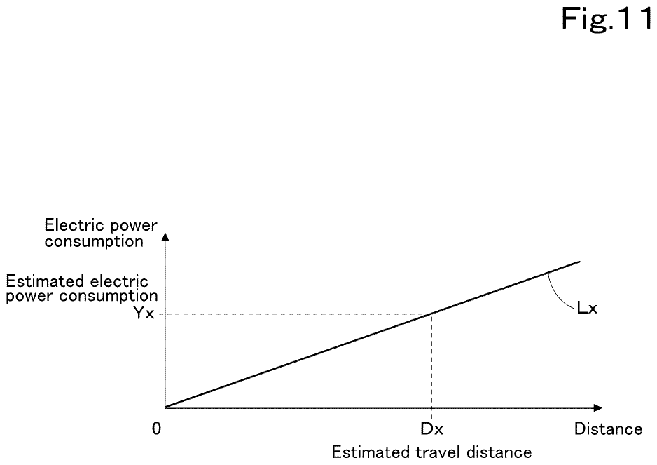

FIG. 11 is a diagram (graph) presenting an example of the relationship between the estimated travel distance and the estimated electric power consumption of the electric working vehicle 1. In the graph presented in FIG. 11, the horizontal axis represents the distance, and the vertical axis represents the electric power consumption. A line Lx indicated by a thick solid line in FIG. 11 indicates the correspondence between the estimated travel distance and the estimated electric power consumption when the electric working vehicle 1 travels without work performed by the working device 4. Control data (second control data) exhibiting the line Lx is stored in the memory 11b in the form of a linear function, a table, or the like.

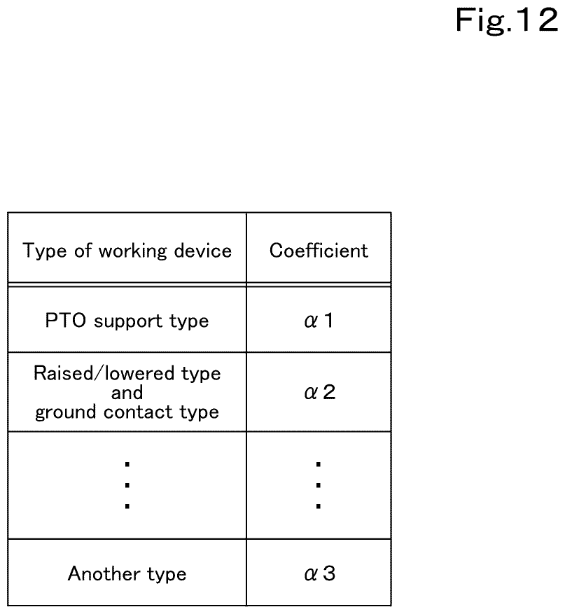

The controller 11 calculates the estimated travel distance Dx as described above, and then determines an estimated electric power consumption Yx corresponding to the estimated travel distance Dx from the control data of the line Lx. Then, the controller 11 multiplies the estimated electric power consumption Yx by a first coefficient α1 corresponding to the working device of the PTO support type to calculate an estimated electric power consumption Y1 corresponding to the working device of the PTO support type. For example, as presented in FIG. 12, control data (third control data) indicating the correspondence between the type of the working device 4 and the coefficient may be stored in the memory 11b, and the controller 11 may select the coefficient corresponding to the type of the working device 4.

If the estimated electric power consumption Y1 is equal to or greater than a first permissible value (S17 in FIG. 8A: NO), the controller 11 performs the first stop control (S20). The first permissible value is set to a value which is greater than 0 (zero). For example, the first permissible value may be a value obtained by subtracting a predetermined minimum remaining charge (permissible minimum amount of electric power kWh) permissible in the high-voltage battery 12 from a remaining charge (remaining amount of electric power kWh) of the high-voltage battery 12 calculated based on the state of charge (the state of charge detected in step S1 in FIG. 6) of the high-voltage battery 12 estimated by the controller 11 at this time. The minimum remaining charge may be, for example, about 10% of the amount of electric power of the high-voltage battery 12 when fully charged. In other words, step S17 is a process of determining whether the remaining charge of the high-voltage battery 12 exceeds the amount of electric power to be consumed by the electric working vehicle 1 performing the work-and-travel to the first predetermined point while the PTO shaft 7j is rotationally driven or not.

If the estimated electric power consumption Y1 is less than the first permissible value (S17: YES), the controller 11 causes the inverter-for-PTO 7i to continue to supply the electric power to the motor-for-PTO 7m to continue to rotationally drive the PTO shaft 7j (S18). Accordingly, the work by the working device 4 is continued, and the work-and-travel of the electric working vehicle 1 is also continued. Then, when detecting that the position of the vehicle body 2 reaches the first predetermined point (S19), the controller 11 performs the first stop control (S20).

After performing the first stop control, when determining that the type of the working device 4 is the raised/lowered type and the ground contact type (second working device) (S21: YES), the controller 11 performs a second stop control (S22). In the second stop control, the controller 11 causes the lift cylinder 6e (raising/lowering mechanism 6) to raise the working device 4 to bring the working device 4 into a predetermined position in which at least a work tool of the working device 4 is not in contact with the ground surface. At this time, when the type of the working device 4 is the directly mounted type, the lift cylinder 6e (raising/lowering mechanism 6) is caused to raise the working device 4 to the predetermined position. Thus, the entire working device 4 is not in contact with the ground surface. Accordingly, the electric working vehicle 1 during the travel-without-work does not drag the working device 4, or the work that is performed only by dragging the working device 4 is stopped, and the load (resistance force) on the electric working vehicle 1 is reduced.

After performing the first stop control (S20), when not determining that the type of the working device 4 is the raised/lowered type and the ground contact type (second working device) (S21: NO), the controller 11 does not perform the second stop control.

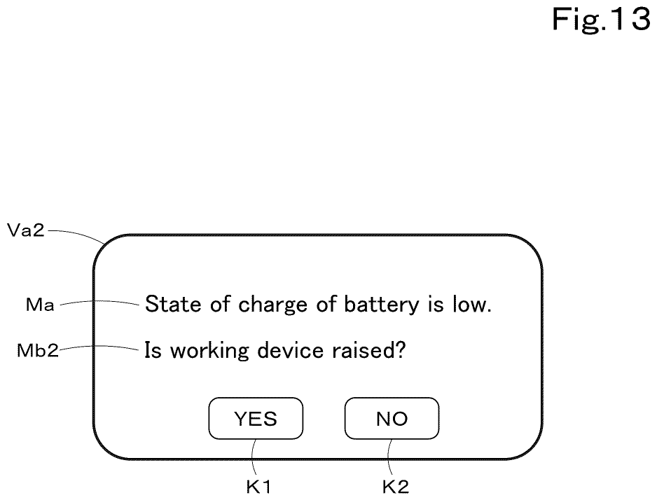

The controller 11 determines that the type of the working device 4 is not the PTO support type (first working device) (S13: NO), but is the raised/lowered type and the ground contact type (second working device) (S23 in FIG. 8B: YES). In this case, the controller 11 causes the user interface 20 to output second information asking whether raising the working device 4 is acceptable or not (S24). At this time, the controller 11 causes the touch screen included in the user interface 20 to display, for example, second information Va2 as illustrated in FIG. 13.

The second information Va2 includes, as messages, information Ma indicating that the state of charge of the high-voltage battery 12 is low and information Mb2 asking whether raising the working device 4 is acceptable or not. The second information Va2 includes a YES key K1 and a NO key K2.

When the operator operates the YES key K1 included in the second information Va2, the controller 11 determines that an instruction to accept raising the working device 4 is received (S25 in FIG. 8B: YES), and performs the second stop control (S30). Accordingly, the working device 4 is raised by the lift cylinder 6e (raising/lowering mechanism 6) and is brought into the predetermined position in which at least the work tool of the working device 4 is not in contact with the ground surface. Thus, the work by the working device 4 is stopped. At this time, the controller 11 also performs the travel-without-work in which the controller 11 causes the vehicle body 2 to travel while causing the working device 4 to stop performing the work.

The controller 11 may perform the second stop control after a predetermined time elapses since the position of the vehicle body 2 reaches the first predetermined point such that at least the work tool of the working device 4 is separated from the ground surface and the work by the working device 4 is stopped when the working device 4 reaches the first predetermined point. The controller 11 may cause the user interface 20 to output the stop information Vb (FIG. 10) also when performing the second stop control in step S30. When performing the second stop control (S30), the controller 11 may add, to the stop information Vb, at least one of information indicating that the working device 4 is raised or information indicating that the travel of the electric working vehicle 1 is not stopped.

When the operator operates the NO key K2 included in the second information Va2 (FIG. 13), the controller 11 determines that an instruction to not accept raising the working device 4 is received (S25 in FIG. 8B: NO). Then, the controller 11 calculates estimated electric power consumption which is an electric power estimated to be consumed by the electric working vehicle 1 if the work-and-travel of the electric working vehicle 1 is continued until the vehicle body 2 reaches the first predetermined point (end point P2a) (S26). At this time, the controller 11 calculates estimated electric power consumption corresponding to the working device of the raised/lowered type and the ground contact type. That is, the controller 11 calculates estimated electric power consumption which is an electric power estimated to be consumed by the electric working vehicle 1 if the work-and-travel of the electric working vehicle 1 is continued while the working device 4 (at least the work tool) is in contact with the ground surface until the vehicle body 2 reaches the first predetermined point.

Specifically, the controller 11 calculates an estimated travel distance Dx as described above, and determines an estimated electric power consumption Yx corresponding to the estimated travel distance Dx. Then, the controller 11 multiplies the estimated electric power consumption Yx by a second coefficient α2 (FIG. 12) corresponding to the working device of the raised/lowered type and the ground contact type to calculate an estimated electric power consumption Y2 corresponding to the working device of the raised/lowered type and the ground contact type.

If the estimated electric power consumption Y2 is equal to or greater than a second permissible value (S27 in FIG. 8B: NO), the controller 11 performs the second stop control (S30). The second permissible value is set to a value which is greater than 0 (zero). The second permissible value may be the same value as the first permissible value of step S17 in FIG. 8A. The second permissible value may be calculated by the controller 11, for example, similarly to the first permissible value. In other words, step S27 is a process of determining whether the remaining charge of the high-voltage battery 12 exceeds the amount of electric power to be consumed by the electric working vehicle 1 performing the work-and-travel to the first predetermined point while the working device 4 is in contact with the ground surface or not.

If the estimated electric power consumption Y2 is less than the second permissible value (S27: YES), the controller 11 does not cause the lift cylinder 6e (raising/lowering mechanism 6) to raise the working device 4, and continues the state in which at least the work tool of the working device 4 is in contact with the ground surface (S28). Accordingly, the work by the working device 4 is continued, and the work-and-travel of the electric working vehicle 1 is also continued. Then, when detecting that the position of the vehicle body 2 reaches the first predetermined point (S29), the controller 11 performs the second stop control (S30).

The controller 11 determines that the type of the working device 4 is not the PTO support type (first working device) (S13: NO), and is not the raised/lowered type and the ground contact type (second working device) (S23: NO), but is another type (third working device). At this time, the controller 11 may determine that the type of the working device 4 is, for example, the towed type and the non-driven work type. Then, the controller 11 calculates estimated electric power consumption which is an electric power estimated to be consumed by the electric working vehicle if the travel of the electric working vehicle 1 is continued until the vehicle body 2 reaches a second predetermined point (S31). At this time, the controller 11 calculates estimated electric power consumption corresponding to the other working device.

Specifically, for example, based on map information relating to a region including the agricultural field H1 stored in the memory 11b, the controller 11 determines that the second predetermined point is a storage location of the electric working vehicle 1 included in the region. Then, the controller 11 calculates an estimated travel distance Dx to be traveled by the electric working vehicle 1 from the position (current position) of the vehicle body 2 detected by the position detector 23 to the second predetermined position. Next, the controller 11 determines an estimated electric power consumption Yx corresponding to the estimated travel distance Dx from the control data of the line Lx in FIG. 11. Then, the controller 11 multiplies the estimated electric power consumption Yx by a third coefficient α3 (FIG. 12) corresponding to the other working device to calculate an estimated electric power consumption Y3 corresponding to the other working device.

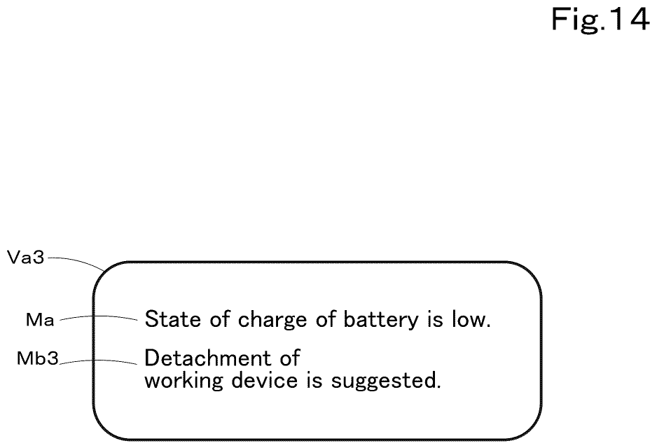

If the estimated electric power consumption Y3 is equal to or greater than the third permissible value (S32: YES), the controller 11 causes the user interface 20 to output third information suggesting that the working device 4 be detached from the vehicle body 2 (S33). At this time, the controller 11 causes the touch screen included in the user interface 20 to display, for example, third information Va3 as illustrated in FIG. 14. The third information Va3 includes, as message, information Ma indicating that the state of charge of the high-voltage battery 12 is low and information Mb3 suggesting that the working device 4 be detached from the vehicle body 2.

If the estimated electric power consumption Y3 is less than the third permissible value (S32 in FIG. 8B: NO), the controller 11 does not output the third information Va3. The third permissible value is set to a value which is greater than 0 (zero). The second predetermined point (storage location) is determined to be a position farther away from the electric working vehicle 1 than the planned first predetermined point (the closest one end point P2a of the plurality of straight portions Z1a of the planned travel route Z1). The third permissible value may be calculated by the controller 11, for example, similarly to the first permissible value. In other words, step S32 is a process of determining whether the remaining charge of the high-voltage battery 12 exceeds the amount of electric power to be consumed by the electric working vehicle 1 performing the work-and-travel to the second predetermined point while the electric working vehicle 1 tows the working device 4 or not.

As described above, when the type of the working device 4 is not the PTO support type (S13 in FIG. 8A: NO) and is not the raised/lowered type and the ground contact type (S23 in FIG. 8B: NO), the controller 11 does not cause the working device 4 to stop performing the work and continues to cause the electric working vehicle 1 to perform the work-and-travel.

As another example, if the estimated electric power consumption Y3 is less than the third permissible value (S32: NO), the controller 11 may repeat step S31 and subsequent steps. Similarly to the first predetermined point, the controller 11 may determine that the second predetermined point is one end point P2a of the end points P2 of the plurality of straight portions Z1a included in the planned travel route Z1 (FIG. 5) of the agricultural field H1 that is present in the direction of travel of the vehicle body 2 and that is closest from the position of the vehicle body 2. In this case, the third permissible value may be the same value as at least one of the first permissible value or the second permissible value.

In addition to the above, examples of the type of the working device 4 that can be connected to the vehicle body 2 include an electric type (fourth working device) the working device of which is driven by electric power supplied from an externally power-supplying circuit 32 (FIG. 1) provided in the electric working vehicle 1 via an electric wire or the like. The externally power-supplying circuit 32 is an electric circuit that supplies electric power from the high-voltage battery 12 to an external device. The working device of the electric type includes an accessory electric actuator that is actuated by the electric power supplied from the externally power-supplying circuit 32 (electric working vehicle 1), and drives a work tool or a rotor by power output from the accessory electric actuator.

When the type of the working device 4 determined based on device information and/or the like is the electric type, the controller 11 inputs a control signal to a switch 32s provided in the externally power-supplying circuit 32 to turn on the switch 32s (close the circuit). Thus, the electric power is supplied from the high-voltage battery 12 to the working device 4 via the externally power-supplying circuit 32, the switch 32s, and the like to drive the working device 4. The switch 32s is, for example, a normally open type relay.

Examples of the type of the working device 4 that can be connected to the vehicle body 2 include a hydraulic type (fifth working device) the working device of which is driven by a pressure of hydraulic fluid supplied from an externally fluid-supplying circuit 31c (FIG. 1) provided in the electric working vehicle 1 via a hose or the like. The externally fluid-supplying circuit 31c is a hydraulic circuit that supplies hydraulic fluid from the hydraulic pump 31p to an external device. The working device of the hydraulic type includes an accessory hydraulic actuator that is actuated by the pressure of the hydraulic fluid supplied from the externally fluid-supplying circuit 31c (electric working vehicle 1), and drives a work tool or a rotor by power output from the accessory hydraulic actuator.

When the type of the working device 4 determined based on the device information and/or the like is the hydraulic type, the controller 11 inputs a control signal to a control valve 31d provided in the externally fluid-supplying circuit 31c to open the control valve 31d. Thus, the hydraulic fluid is supplied from the hydraulic pump 31p to the working device 4 via the externally fluid-supplying circuit 31c, the control valve 31d, and the like to drive the working device 4. The control valve 31d is a solenoid valve.

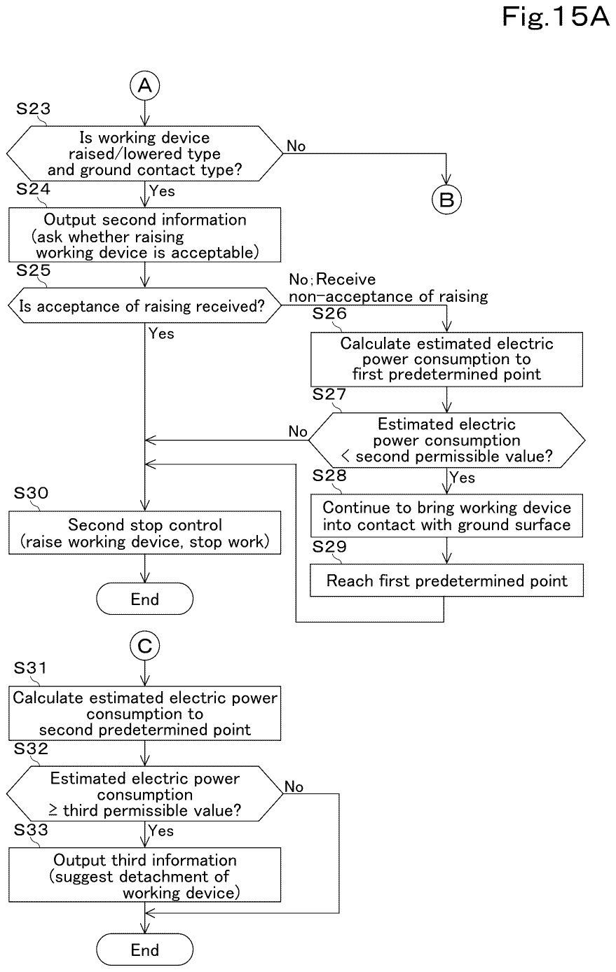

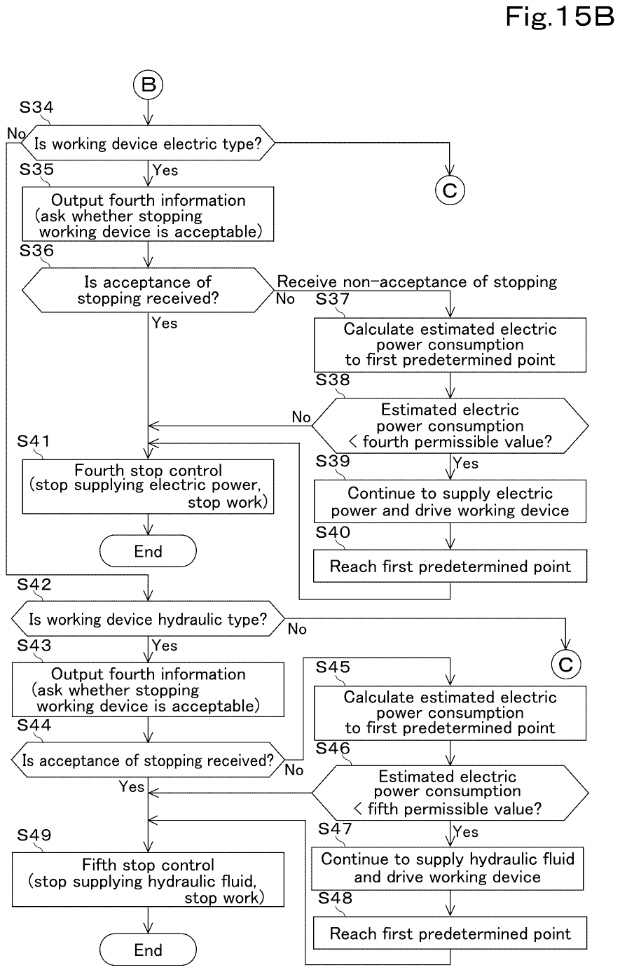

Assuming that the working device of the electric type and the working device of the hydraulic type are connected to the vehicle body 2, the controller 11 may perform, for example, the forced work-stop mode as presented in FIGS. 15A and 15B. FIGS. 15A and 15B are flowcharts presenting another example of the operation of the electric working vehicle 1 in the forced work-stop mode. Each step presented in FIGS. 15A and 15B is performed instead of each step in FIG. 8B when a negative determination (NO) is made in step S13 in FIG. 8A. In FIG. 15A, the same steps as those in FIG. 8B are denoted by the same reference signs. In another flowchart described later, the same steps as those in the above-described flowchart are denoted by the same reference signs.

The controller 11 determines that the type of the working device 4 is not the PTO support type (S13 in FIG. 8A: NO), and is not the raised/lowered type and the ground contact type (S23 in FIG. 15A: NO), but is the electric type (fourth working device) (S34 in FIG. 15B: YES). In this case, the controller 11 causes the user interface 20 to output fourth information asking whether stopping the working device 4 is acceptable or not (S35).

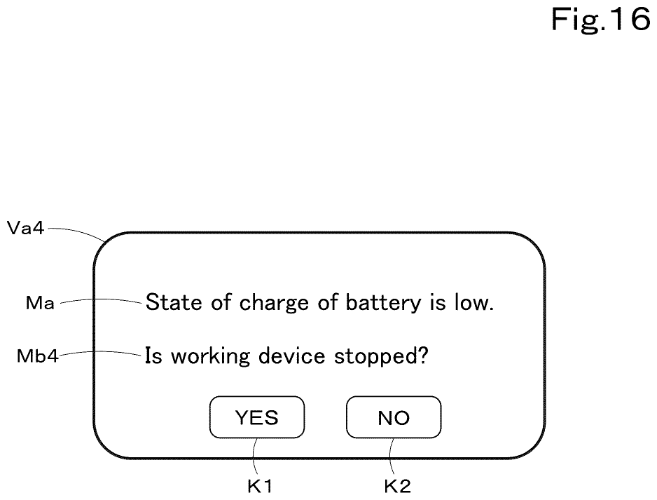

At this time, the controller 11 causes the touch screen included in the user interface 20 to display, for example, fourth information Va4 as illustrated in FIG. 16. The fourth information Va4 includes, as messages, information Ma indicating that the state of charge of the high-voltage battery 12 is low and information Mb4 asking whether stopping the working device 4 is acceptable or not. The fourth information Va4 includes a YES key K1 and a NO key K2.

When receiving an instruction to accept stopping the working device 4 by the operation of the YES key K1 (S36 in FIG. 15B: YES), the controller 11 performs a fourth stop control (S41). In the fourth stop control, the controller 11 stops the input of the control signal to the switch 32s provided in the externally power-supplying circuit 32 (FIG. 1) to turn off the switch 32s to stop the electric power from being supplied from the externally power-supplying circuit 32 to the working device 4. Accordingly, the electric power is not supplied from the high-voltage battery 12 to the working device 4 via the externally power-supplying circuit 32, the switch 32s, and the like, the driving of the work tool or the rotor of the working device 4 is stopped, and the work by the working device 4 is stopped. At this time, the controller 11 also performs the travel-without-work in which the controller 11 causes the vehicle body 2 to travel while causing the working device 4 to stop performing the work.

The controller 11 may perform the fourth stop control after a predetermined time elapses since the position of the vehicle body 2 reaches the first predetermined point such that the driving of the working device 4 is stopped and the work by the working device 4 is stopped when the working device 4 reaches the first predetermined point. The controller 11 may cause the user interface 20 to output the stop information Vb (FIG. 10) also when performing the fourth stop control (S41). When performing the fourth stop control, the controller 11 may add information indicating that the travel of the electric working vehicle 1 is not stopped to the stop information Vb. The same applies to the case where a fifth stop control described later is performed (S49 in FIG. 15B).

When receiving an instruction to not accept stopping the working device 4 by the operation of the NO key K2 (S36: NO), the controller 11 calculates estimated electric power consumption which is an electric power estimated to be consumed by the electric working vehicle 1 if the work-and-travel of the electric working vehicle 1 is continued until the vehicle body 2 reaches the first predetermined point (S37). At this time, the controller 11 calculates estimated electric power consumption corresponding to the working device of the electric type. That is, the controller 11 calculates estimated electric power consumption which is an electric power estimated to be consumed by the electric working vehicle 1 if the work-and-travel of the electric working vehicle 1 is continued while the working device of the electric type is driven until the vehicle body 2 reaches the first predetermined point.

Specifically, the controller 11 calculates an estimated travel distance Dx as described above, determines an estimated electric power consumption Yx corresponding to the estimated travel distance Dx, and then multiplies the estimated electric power consumption Yx by a fourth coefficient α4 corresponding to the working device of the electric type to calculate an estimated electric power consumption Y4 corresponding to the working device of the electric type. Although the fourth coefficient α4 corresponding to the working device of the electric type is not presented in FIG. 12, the fourth coefficient α4 is included in the control data indicating the correspondence between the type of the working device 4 and the coefficient, and is stored in the memory 11b. The same applies to a fifth coefficient α5 described later.

If the estimated electric power consumption Y4 is equal to or greater than a fourth permissible value (S38 in FIG. 15B: NO), the controller 11 performs the fourth stop control (S41). The fourth permissible value is set to a value which is greater than 0 (zero). The fourth permissible value may be the same value as at least one of the first permissible value or the second permissible value, or may be a value which differs from the first permissible value and the second permissible value. The fourth permissible value may be calculated by the controller 11, for example, similarly to the first permissible value. The same applies to a fifth permissible value described later.

If the estimated electric power consumption Y4 is less than the fourth permissible value (S38: YES), the controller 11 does not stop the electric power from being supplied from the externally power-supplying circuit 32 to the working device 4, and continues to drive the working device 4 (S39). Accordingly, the work by the working device 4 is continued, and the work-and-travel of the electric working vehicle 1 is also continued. Then, when detecting that the position of the vehicle body 2 reaches the first predetermined point (S40), the controller 11 performs the fourth stop control (S41).

The controller 11 determines that the type of the working device 4 is not the PTO support type, is not the raised/lowered type and the ground contact type, and is not the electric type (S13 in FIG. 8A: NO, S23 in FIG. 15A: NO, S34 in FIG. 15B: NO), but is the hydraulic type (fifth working device) (S42: YES). In this case, the controller 11 causes the user interface 20 to output the fourth information Va4 (FIG. 16) (S43).

When receiving an instruction to accept stopping the working device 4 by the operation of the YES key K1 (S44: YES), the controller 11 performs a fifth stop control (S49). In the fifth stop control, the controller 11 stops the input of the control signal to the control valve 31d provided in the externally fluid-supplying circuit 31c (FIG. 1) to close the control valve 31d to stop the hydraulic fluid from being supplied from the externally fluid-supplying circuit 31c to the working device 4. Accordingly, the hydraulic fluid is not supplied from the hydraulic pump 31p to the working device 4 via the externally fluid-supplying circuit 31c, the control valve 31d, and the like, the driving of the work tool or the rotor of the working device 4 is stopped, and the work by the working device 4 is stopped. At this time, the controller 11 also performs the travel-without-work in which the controller 11 causes the vehicle body 2 to travel while causing the working device 4 to stop performing the work.

When receiving an instruction to not accept stopping the working device 4 by the operation of the NO key K2 (S44 in FIG. 15B: NO), the controller 11 calculates estimated electric power consumption which is an electric power estimated to be consumed by the electric working vehicle 1 if the work-and-travel of the electric working vehicle 1 is continued until the vehicle body 2 reaches the first predetermined point (S45). At this time, the controller 11 calculates estimated electric power consumption corresponding to the working device of the hydraulic type. That is, the controller 11 calculates estimated electric power consumption which is an electric power estimated to be consumed by the electric working vehicle 1 if the work-and-travel of the electric working vehicle 1 is continued while the working device of the hydraulic type is driven until the vehicle body 2 reaches the first predetermined point.

Specifically, the controller 11 calculates an estimated travel distance Dx as described above, determines an estimated electric power consumption Yx corresponding to the estimated travel distance Dx, and then multiplies the estimated electric power consumption Yx by a fifth coefficient α5 corresponding to the working device of the hydraulic type to calculate an estimated electric power consumption Y5 corresponding to the working device of the hydraulic type.

Then, if the estimated electric power consumption Y5 is equal to or greater than a fifth permissible value (S46: NO), the controller 11 performs the fifth stop control (S49). In contrast, if the estimated electric power consumption Y5 is less than the fifth permissible value (S46: YES), the controller 11 does not stop the hydraulic fluid from being supplied from the externally fluid-supplying circuit 31c to the working device 4, and continues to drive the working device 4 (S47). Accordingly, the work by the working device 4 is continued, and the work-and-travel of the electric working vehicle 1 is also continued. Then, when detecting that the position of the vehicle body 2 reaches the first predetermined point (S48: YES), the controller 11 performs the fifth stop control (S49).

The controller 11 determines that the type of the working device 4 is not the PTO support type, is not the raised/lowered type and the ground contact type, is not the electric type, and is not the hydraulic type (S13 in FIG. 8A: NO, S23 in FIG. 15A: NO, S34 in FIG. 15B: NO, S42 in FIG. 15B: NO), but is another type (third working device). In this case, the controller 11 performs steps S31 to S33 in FIG. 15A.

After step S41 or step S49 in FIG. 15B, the controller 11 may perform the same processes as those of steps S21 and S22 in FIG. 8A. That is, after performing the fourth stop control (S41 in FIG. 15B) or the fifth stop control (S49), when determining that the type of the working device 4 is the raised/lowered type and the ground contact type (S21 in FIG. 8A: YES), the controller 11 may perform the second stop control (S22) to cause the lift cylinder 6e (raising/lowering mechanism 6) to raise the working device 4 to bring the working device 4 into the predetermined position in which at least the work tool of the working device 4 is not in contact with the ground surface.

After causing the working device 4 to stop performing the work, the controller 11 may cause the inverters-for-travel 14Lf, 14Rf, 14Lr, and 14Rr to adjust the electric power supplied to the motors-for-travel 3Lf, 3Rf, 3Lr, and 3Rr. For example, while limiting the electric power supplied to the motors-for-travel 3Lf, 3Rf, 3Lr, and 3Rr after causing the working device 4 to stop performing the work, the controller 11 may stop limiting the electric power. Then, the controller 11 may cause the inverters-for-travel 14Lf, 14Rf, 14Lr, and 14Rr to supply the electric power to the motors-for-travel 3Lf, 3Rf, 3Lr, and 3Rr according to the target rotation speed.

Alternatively, while limiting the electric power supplied to at least one of the motor-for-travel 3Lf, 3Rf, 3Lr, or 3Rr after causing the working device 4 to stop performing the work, the controller 11 may further limit (reduce) the electric power supplied to at least one of the motor-for-travel 3Lf, 3Rf, 3Lr, or 3Rr. Additionally or alternatively, while not limiting the electric power supplied to the motors-for-travel 3Lf, 3Rf, 3Lr, and 3Rr after causing the working device 4 to stop performing the work, the controller 11 may limit the electric power.

After causing the working device 4 to stop performing the work, the controller 11 may cause the inverters-for-travel 14Lf, 14Rf, 14Lr, and 14Rr to adjust the electric power supplied to the motors-for-travel 3Lf, 3Rf, 3Lr, and 3Rr according to the stop control performed to stop the work. For example, while limiting the electric power supplied to the motors-for-travel 3Lf, 3Rf, 3Lr, and 3Rr, when performing the first stop control (S20), the controller 11 stops limiting the electric power, and when performing the second stop control (S30), the controller 11 does not stop limiting the electric power. Additionally or alternatively, while limiting the electric power supplied to the motors-for-travel 3Lf, 3Rf, 3Lr, and 3Rr, when performing the fourth stop control (S41), the controller 11 stops limiting the electric power, and when performing the fifth stop control (S49), the controller 11 does not stop limiting the electric power.

Alternatively, while limiting the electric power supplied to the motors-for-travel 3Lf, 3Rf, 3Lr, and 3Rr, when performing the first stop control (S20), the controller 11 may continue to limit the electric power, and when performing the second stop control (S30), the controller 11 may further limit the electric power supplied to at least one of the motor-for-travel 3Lf, 3Rf, 3Lr, or 3Rr. Additionally or alternatively, while limiting the electric power supplied to the motors-for-travel 3Lf, 3Rf, 3Lr, and 3Rr, when performing the fourth stop control (S41), the controller 11 may continue to limit the electric power, and when performing the fifth stop control (S49), the controller 11 may further limit the electric power supplied to at least one of the motor-for-travel 3Lf, 3Rf, 3Lr, or 3Rr.

Additionally or alternatively, while not limiting the electric power supplied to the motors-for-travel 3Lf, 3Rf, 3Lr, and 3Rr, when performing the second stop control (or the fifth stop control) without performing the first stop control (or the fourth stop control), the controller 11 may limit the electric power supplied to at least one of the motor-for-travel 3Lf, 3Rf, 3Lr, or 3Rr.

In the above-described example embodiments, the examples have been presented in which the controller 11 multiplies the estimated electric power consumption Yx determined from the control data of the line Lx in FIG. 11 by the coefficients α1 to α5 corresponding to the type of the working device 4 to calculate the estimated electric power consumptions Y1 to Y5 based on the type of the working device 4, but this does not imply any limitation. Alternatively, for example, control data indicating the correspondence between the estimated travel distance and the estimated electric power consumption during the work-and-travel in which the electric working vehicle 1 travels while the working device 4 performs work may be defined in advance for each type of the working device 4 (the first working device to the fifth working device) and stored in the memory 11b. Then, the controller 11 may read the control data corresponding to the type of the working device 4 from the memory 11b, and determine the estimated electric power consumptions Y1 to Y5 corresponding to the estimated travel distance Dx from the control data.

In the above-described example embodiments, the examples have been presented in which the controller 11 causes the touch screen included in the user interface 20 to display each of the pieces of information V1a to V4a and Vb, but this does not imply any limitation. The controller 11 may output each of the pieces of information Va1 to Va4, Ma, Mb1 to Mb4, Vb, and Mc by voice, for example, from a speaker included in the user interface 20. In this case, the YES key K1 and the NO key K2 may be displayed on the touch screen, or a plurality of hardware-type operation keys included in the user interface 20 may be assigned to the YES key and the NO key. Alternatively, the controller 11 may transmit each of the pieces of information Va1 to Va4, Ma, Mb1 to Mb4, Vb, and Mc to at least one of the external devices such as the terminal device 42 and the remote device 43 via the communication device 24, and cause a user interface of the external device to output each of the pieces of information.

As another example, steps S14 to S19 in FIGS. 8A and 8B and FIG. 15A may be omitted, or steps S24 to S29 in FIGS. 8B and 15A may be omitted. Steps S35 to S39 in FIG. 15B may be omitted, or steps S44 to S48 in FIG. 15B may be omitted. Steps S31 and S32 in FIGS. 8B and 15A may be omitted, or step S33 in FIGS. 8B and 15A may be omitted. As the type of the working device 4 that can be connected to the vehicle body 2 (electric working vehicle 1), one of the electric type or the hydraulic type may be excluded, and steps S34 to S41 or steps S42 to S49 in FIG. 15B may be omitted.

As the type of the working device 4, there is a working device that includes an accessory lift actuator that raises and lowers at least a work tool of the working device 4, and performs work while the accessory lift actuator causes the work tool to be in contact with the ground surface. There is also a working device that includes not only the accessory lift actuator but also an accessory raising/lowering mechanism that is actuated by the accessory lift actuator to raise and lower at least the work tool. These working devices are also working devices of the raised/lowered type and the ground contact type (second working devices). The accessory lift actuator is an electric or hydraulic cylinder, an electric or hydraulic motor, or the like. The accessory lift actuator is actuated by the electric power supplied from the externally power-supplying circuit 32 or the hydraulic fluid supplied from the externally fluid-supplying circuit 31c.

When the working device 4 including the accessory lift actuator as described above is connected to the vehicle body 2, the controller 11 is configured or programmed to control, for example, the electric power supplied from the high-voltage battery 12 to the working device 4 via the externally power-supplying circuit 32 or the like to actuate the accessory lift actuator to cause the accessory lift actuator or the like to raise and lower at least the work tool of the working device 4. Alternatively, the controller 11 is configured or programmed to control the hydraulic fluid supplied from the hydraulic pump 31p to the working device 4 via the externally fluid-supplying circuit 31c or the like to actuate the accessory lift actuator to cause the accessory lift actuator or the like to raise and lower at least the work tool of the working device 4.

As described above, the controller 11 causes the accessory lift actuator (accessory raising/lowering mechanism) to lower at least the work tool to bring the work tool into contact with the ground surface to cause the working device 4 to perform the work. The controller 11 causes the accessory lift actuator (accessory raising/lowering mechanism) to raise at least the work tool to bring the work tool into non-contact with the ground surface to cause the working device 4 to stop performing the work. In the forced work-stop mode, while the electric working vehicle 1 performs the work-and-travel, when the type of the working device 4 determined based on the device information is the raised/lowered type and the ground contact type the working device of which includes the accessory lift actuator, the controller 11 causes the accessory lift actuator to bring the work tool into non-contact with the ground surface to cause the working device 4 to stop performing the work (second stop control).

The controller 11 is configured or programmed to control any one of the motor-for-PTO 7m, the lift cylinder 6e, the accessory lift actuator, the switch 32s of the externally power-supplying circuit 32, or the control valve 31d of the externally fluid-supplying circuit 31c based on the type of the working device 4 to cause the working device 4 to stop performing the work.

In the above-described example embodiments, the examples have been presented in which, when the controller 11 transitions to the forced work-stop mode while the electric working vehicle 1 performs the work-and-travel, the controller 11 stops the work based on the type of the working device 4, but this does not imply any limitation. Even while not performing the work-and-travel, when the controller 11 transitions to the forced work-stop mode, the controller 11 may perform the first to fifth stop controls based on the type of the working device 4 to maintain the stop state of the work to cause the working device 4 to not perform the work. Since the work by the working device 4 is stopped in this manner, the load on the electric working vehicle 1 is reduced, and the electric power consumption is reduced.

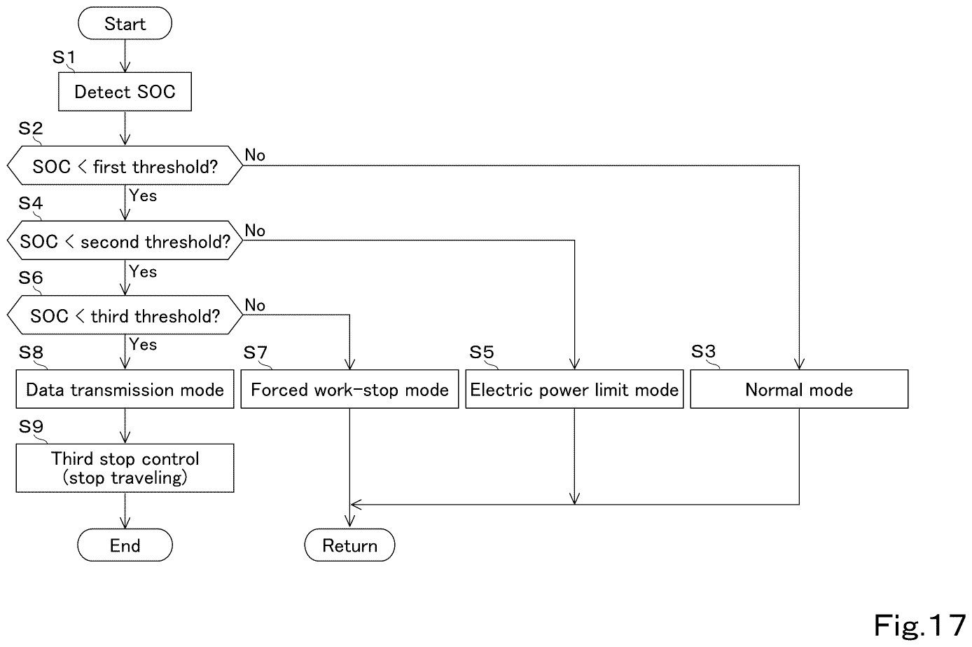

As another example embodiment, as presented in FIG. 17, when the state of charge of the high-voltage battery 12 is less than the third threshold (S6: YES), the controller 11 may perform a third stop control (S9). In the third stop control, the controller 11 causes the inverters-for-travel 14Lf, 14Rf, 14Lr, and 14Rr to stop the electric power from being supplied to the motors-for-travel 3Lf, 3Rf, 3Lr, and 3Rr to stop rotationally driving the driving wheels 5Lf, 5Rf, 5Lr, and 5Rr to cause the vehicle body 2 to stop traveling. Accordingly, even when the work is performed by the working device 4 at this time, the work is stopped.

In the data transmission mode (S8), the controller 11 transmits the status information of the electric working vehicle 1 to the server 41 or the like via the communication device 24. At this time, the controller 11 may determine information to be added to the status information according to the communication state, the presence/absence of a person in the electric working vehicle 1, and the presence/absence of the working device 4.

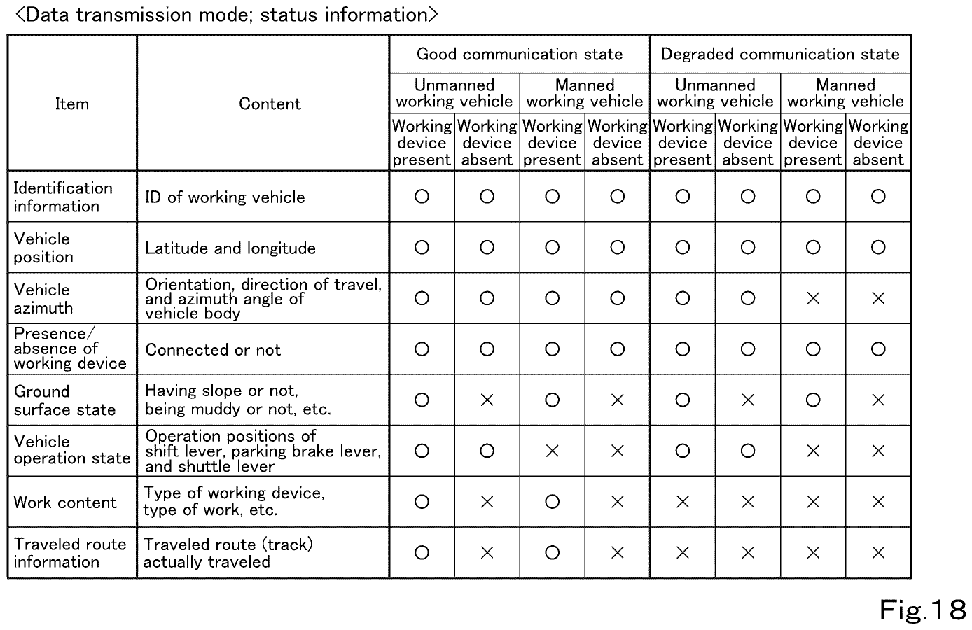

FIG. 18 is a diagram presenting an example of information transmitted in the data transmission mode in the form of a table. The controller 11 adds identification information (ID) of the electric working vehicle 1 to the status information of the electric working vehicle 1 transmitted in the data transmission mode. The controller 11 adds at least one of the vehicle position, the vehicle azimuth, the presence/absence of the working device, the ground surface state, the vehicle operation state, the work content, or the vehicle route to the status information.

The vehicle position is the position of the vehicle body 2 detected by the position detector 23 and is represented by the latitude and the longitude. The vehicle azimuth is the orientation (direction of travel) of the vehicle body 2 and is represented by the azimuth angle. The controller 11 calculates the orientation of the vehicle body 2 based on the time-series position data of the vehicle body 2 detected by the position detector 23. Alternatively, the controller 11 may calculate the orientation of the vehicle body based on the yaw angle of the vehicle body 2 detected by the IMU 21c. The presence/absence of the working device is whether the working device 4 is connected to the vehicle body 2 or not, and is indicated by the device information. Alternatively, the controller 11 may determine whether the working device 4 is connected to the vehicle body 2 or not from the captured image of the rear area of the vehicle body 2 captured by the camera 22c.

The ground surface state includes whether the ground surface on which the electric working vehicle 1 is located has a slope or not, whether the ground surface is muddy or not, and the like. The controller 11 determines the sloping direction and the angle of slope as the sloping state of the ground surface from, for example, the pitch angle and the roll angle of the vehicle body 2 detected by the IMU 21c. Alternatively, the controller 11 may determine the sloping direction and the angle of slope of the ground surface from the captured image of the surrounding area of the electric working vehicle 1 captured by the camera 22c. The controller 11 may determine whether the ground surface is muddy or not as the soil state of the ground surface from, for example, the captured image of the camera 22c.

The vehicle operation state is the operation state by the operation assembly 10 of the electric working vehicle 1, and includes, for example, the operation positions of the shift lever 10c, the parking brake lever 10e, and the shuttle lever 10f detected by sensors. The work content includes the device information, the type of the working device 4 indicated by the device information, the type of the work performed by the working device 4, and the like. The controller 11 determines whether the working device 4 is performing the work or stops performing the work from the actuation state of at least one of the motor-for-PTO 7m, the lift cylinder 6e, the switch 23s, or the control valve 31d. The vehicle route is an actual traveled route (track) traveled by the vehicle body 2 (along which the vehicle body 2 has moved). The controller 11 calculates the traveled route of the vehicle body 2 based on the time-series position data of the vehicle body 2 periodically detected by the position detector 23 since the start key 10a is operated to be turned on last. The above-described pieces of information are examples, and this does not imply any limitation.

The controller 11 communicates with the server 41 via the wide-area communication module 24c of the communication device 24, and determines that the communication state is good when the reception intensity (for example, RSSI) of the wireless signal received via the wide-area communication module 24c is equal to or greater than a predetermined value, and determines that the communication state is degraded when the reception intensity is less than the predetermined value. The controller 11 determines whether the electric working vehicle 1 is a manned working vehicle on which an operator rides or an unmanned working vehicle on which an operator does not ride, from the vehicle information including the specifications of the electric working vehicle 1 stored in the memory 11b. Alternatively, an occupant sensor that detects the presence/absence of a person may be provided in the cabin 9, and the controller 11 may determine whether the electric working vehicle 1 is manned or unmanned based on the presence/absence of a person detected by the occupant sensor.

When the electric working vehicle 1 is an unmanned working vehicle, the degree of risk is higher than that when the electric working vehicle 1 is a manned working vehicle. When the working device 4 is connected to the electric working vehicle 1, the degree of risk is higher than that when the working device 4 is not connected to the electric working vehicle 1. When the state of charge of the high-voltage battery 12 decreases to be less than the third threshold, the controller 11 determines information to be added to the status information according to the degree of risk and the communication state of the electric working vehicle 1 in order to reduce the electric power consumption.

In the example of FIG. 18, in the case where the communication state is good, when the electric working vehicle 1 is unmanned and the working device 4 is connected, the controller 11 adds the vehicle position, the vehicle azimuth, the presence/absence of the working device, the ground surface state, the vehicle operation state, the work content, and the traveled route information to the status information. Also, when the electric working vehicle 1 is unmanned and the working device 4 is not connected, the controller 11 adds the vehicle position, the vehicle azimuth, the presence/absence of the working device, and the vehicle operation state to the status information. Also, when the electric working vehicle 1 is manned and the working device 4 is connected, the controller 11 adds the vehicle position, the vehicle azimuth, the presence/absence of the working device, the ground surface state, the work content, and the traveled route information to the status information. Also, when the electric working vehicle 1 is manned and the working device 4 is not connected, the controller 11 adds the vehicle position, the vehicle azimuth, and the presence/absence of the working device to the status information.

In the case where the communication state is degraded, when the electric working vehicle 1 is unmanned and the working device 4 is connected, the controller 11 adds the vehicle position, the vehicle azimuth, the presence/absence of the working device, the ground surface state, and the vehicle operation state to the status information. Also, when the electric working vehicle 1 is unmanned and the working device 4 is not connected, the controller 11 adds the vehicle position, the vehicle azimuth, the presence/absence of the working device, and the vehicle operation state to the status information. Also, when the electric working vehicle 1 is manned and the working device 4 is connected, the controller 11 adds the vehicle position, the presence/absence of the working device, and the ground surface state to the status information. Also, when the electric working vehicle 1 is manned and the working device 4 is not connected, the controller 11 adds the vehicle position, and the presence/absence of the working device to the status information.

As described above, the controller 11 reduces the number of pieces of information added to the status information as the degree of risk of the electric working vehicle 1 increases. Even when the degree of risk of the electric working vehicle 1 is high and the communication state is degraded, the controller 11 adds important information such as the vehicle position and the presence/absence of the working device to the status information. The pieces of information presented in FIG. 18 are examples, and this does not imply any limitation. For example, the status information may include other information relating to the electric working vehicle 1, such as the state of charge and the remaining amount of electric power of the high-voltage battery 12 detected by the BMS 15.

In the above-described example embodiments, the examples have been presented in which the present invention is applied to the electric working vehicle 1 including the electric motors 3Lf, 3Lr, 3Rf, and 3Rr, and the like as the prime movers, but this does not imply any limitation. Example embodiments of the present invention may be applied to a hybrid electric working vehicle including an engine in addition to the electric motors 3Lf, 3Lr, 3Rf, and 3Rr.

In the above-described example embodiments, the examples have been presented in which the controller 11 calculates the estimated electric power consumption Yx using the control data indicating the correspondence between the type of the working device 4 and the coefficient as presented in FIG. 12, but this does not imply any limitation. For example, the memory 11b may store data of the electric power consumption corresponding to the travel distance in the case of performing the work-and-travel for each type of the working device 4, and the controller 11 may calculate the estimated electric power consumption Yx corresponding to the type of the working device 4 and the estimated travel distance Dx. The first permissible value of step S17 in FIG. 8A, the second permissible value of step S27 and the third permissible value of step S32 in FIGS. 8B and 15A, and the fourth permissible value of step S38 and the fifth permissible value of step S46 in FIG. 15B may be time constants calculated by the same method and may be simply permissible values.

The electric working vehicles 1 of the example embodiments described above may include the features described in the following items and achieve the following effects.

(Item 1) An electric working vehicle 1 includes driving wheels 5Lf, 5Rf, 5Lr, 5Rr for travel attached to a vehicle body 2, at least one motor-for-travel 3Lf, 3Rf, 3Lr, 3Rr which is at least one electric motor to drive the driving wheels 5Lf, 5Rf, 5Lr, 5Rr, a battery (high-voltage battery) 12, at least one inverter-for-travel 14Lf, 14Rf, 14Lr, 14Rr to supply electric power from the battery 12 to the at least one motor-for-travel 3Lf, 3Rf, 3Lr, 3Rr to drive the at least one motor-for-travel 3Lf, 3Rf, 3Lr, 3Rr, a PTO shaft 7j, a motor-for-PTO 7m which is an electric motor to drive the PTO shaft 7j, an inverter-for-PTO 7i to supply electric power from the battery 12 to the motor-for-PTO 7m to drive the motor-for-PTO 7m, a battery management system (BMS) 15 to monitor a state of the battery 12, an input interface 20, 24, 22c (at least one of a user interface 20, a communication device 24, a camera 22c, or an operation assembly 10) to receive input of device information relating to a working device 4 connected to the vehicle body 2, and a controller 11 configured or programmed to cause the at least one inverter-for-travel 14Lf, 14Rf, 14Lr, 14Rr to control the at least one motor-for-travel 3Lf, 3Rf, 3Lr, 3Rr, cause the inverter-for-PTO 7i to control the motor-for-PTO 7m, and control a lift actuator (lift cylinder(s) 6e or accessory lift actuator(s)) to raise and lower the working device 4. The controller 11 is configured or programmed to perform a work-and-travel in which the controller 11 causes the at least one motor-for-travel 3Lf, 3Rf, 3Lr, 3Rr to drive the driving wheels 5Lf, 5Rf, 5Lr, 5Rr to cause the vehicle body 2 to travel and causes the working device 4 to perform work in an agricultural field H1, determine a type of the working device 4 based on the device information, and according to a state of charge of the battery 12 detected by the BMS 15 and the type of the working device 4, control at least one of the motor-for-PTO 7m or the lift actuator to cause the working device 4 to stop performing the work.

With the configuration of Item 1 described above, the motor-for-PTO 7m is caused to stop driving the working device 4 via the PTO shaft 7j to cause the working device 4 to stop performing the work. Thus, the electric power consumption can be reduced. Furthermore, the lift actuator is caused to raise the working device 4 to cause the working device 4 to stop performing the work. Thus, the load (resistance force) on the electric working vehicle 1 is reduced, and the electric power consumption can be reduced. Accordingly, at least one of the motor-for-PTO 7m or the lift actuator causes the working device 4 to stop performing the work according to the state of charge of the battery 12 and the type of the working device 4. Thus, the flexibility of power saving of the electric working vehicle 1 can be improved.

(Item 2) In the electric working vehicle 1 according to item 1, the controller 11 is configured or programmed to perform the work-and-travel when the state of charge is equal to or greater than a first threshold, when the state of charge is less than the first threshold, perform the work-and-travel while limiting the electric power supplied by the at least one inverter-for-travel 14Lf, 14Rf, 14Lr, 14Rr to the at least one motor-for-travel 3Lf, 3Rf, 3Lr, 3Rr, and when the state of charge is less than a second threshold which is less than the first threshold during the work-and-travel, control at least one of the motor-for-PTO 7m or the lift actuator based on the type of the working device 4 to stop the work and continue to cause the vehicle body 2 to travel.

With the configuration of Item 2 described above, when the state of charge of the battery 12 is less than the first threshold, the electric working vehicle 1 performs the work-and-travel while the electric power supplied to the at least one motor-for-travel 3Lf, 3Rf, 3Lr, or 3Rr is limited. When the state of charge is less than the second threshold, at least one of the motor-for-PTO 7m or the lift actuator stops the work based on the type of the working device 4. Accordingly, the flexibility of power saving at the start of the work-and-travel and during the work-and-travel in the electric working vehicle 1 can be further improved.

(Item 3) In the electric working vehicle 1 according to item 1 or 2, the controller 11 is configured or programmed to, when the state of charge is less than a threshold (second threshold), control at least one of the motor-for-PTO 7m or the lift actuator based on the type of the working device 4 to stop the work.

With the configuration of Item 3 described above, at least one of the motor-for-PTO 7m or the lift actuator suspends the start of the work to be performed by the working device 4 or stop the work being performed by the working device 4 according to the state of charge of the battery 12 and the type of the working device 4. Accordingly, the flexibility of power saving at the start of the work-and-travel or during the work-and-travel in the electric working vehicle 1 can be further improved.

(Item 4) In the electric working vehicle 1 according to any one of items 1 to 3, the controller 11 is configured or programmed to, when the state of charge is less than a threshold (second threshold) during the work-and-travel, perform at least one of a first stop control or a second stop control based on the type of the working device to stop the work. The controller 11 is configured or programmed to, in the first stop control, cause the inverter-for-PTO 7i and the motor-for-PTO 7m to stop driving the PTO shaft 7j to stop driving a rotor of the working device 4 connected to the PTO shaft 7j. The controller 11 is configured or programmed to, in the second stop control, cause the lift actuator to raise the working device 4 to bring the working device 4 into a predetermined position in which at least a work tool of the working device 4 is not in contact with a ground surface.

With the configuration of Item 4 described above, when the state of charge of the battery 12 is less than the threshold (second threshold), the electric power consumption in the PTO can be set to zero and/or the electric power consumption by towing the working device 4 can be set to zero or reduced as appropriate based on the type of the working device 4.

(Item 5) In the electric working vehicle 1 according to item 4, the controller 11 is configured or programmed to perform the first stop control when the type of the working device 4 is a first working device to be driven by a driving force of the PTO shaft 7j, and perform the second stop control when the type of the working device 4 is a second working device to be raised and lowered by the lift actuator and to perform the work while in contact with the ground surface.

With the configuration of Item 5 described above, when the first working device of the PTO support type is connected to the electric working vehicle 1, the motor-for-PTO 7m is caused to stop driving the first working device via the PTO shaft 7j to stop the work. Thus, the electric power consumption can be reduced. Furthermore, when the second working device of the raised/lowered type and the ground contact type is connected to the electric working vehicle 1 instead of the first working device of the PTO support type, the lift actuator is caused to raise the second working device to the position in which the second working device is not in contact with the ground surface to stop the work. Thus, the load on the electric working vehicle 1 is reduced, and the electric power consumption can be reduced. Further, when the working device 4 of the PTO support type, the raised/lowered type, and the ground contact type, that is, the working device 4 that is the first working device and the second working device is connected to the electric working vehicle 1, the motor-for-PTO 7m or the like is caused to stop driving the working device 4 and the lift actuator is caused to raise the working device 4 to stop the work. Thus, the electric power consumption can be further reduced.

(Item 6) In the electric working vehicle 1 according to item 5, the controller 11 is configured or programmed to, when the type of the working device 4 is the first working device, cause a user interface (user interface 20 or a user interface of a terminal device 42 or of a remote device 43) to output first information Va1 asking whether stopping the PTO shaft 7j is acceptable or not, and perform the first stop control when an instruction to accept stopping the PTO shaft 7j is received via the user interface.

With the configuration of Item 6 described above, the PTO shaft 7j is stopped to cause the working device 4 to stop performing the work after the acceptance is obtained from the user. Thus, it is possible to eliminate or reduce the likelihood that the user has a sense of distrust in the operation of the electric working vehicle 1. Furthermore, the user can determine whether to stop or continue the work in consideration of the work state of the electric working vehicle 1 and the working device 4, and thus convenience is improved.

(Item 7) The electric working vehicle 1 according to item 6 further includes a position detector 23 to detect a position of the vehicle body 2 using a satellite positioning system, and the controller 11 is configured or programmed to, when an instruction to not accept stopping the PTO shaft 7j is received via the user interface, calculate estimated electric power consumption which is an electric power estimated to be consumed by the electric working vehicle if the work-and-travel is continued until the vehicle body 2 reaches a first predetermined point, and perform the first stop control if the estimated electric power consumption is equal to or greater than a first permissible value.

With the configuration of Item 7 described above, if the electric working vehicle 1 continues to perform the work-and-travel without stopping the PTO shaft 7j in response to the instruction from the user, the first stop control can prevent or reduce overdischarge of the battery 12. Furthermore, the first stop control can prevent or reduce deterioration of the battery 12.

(Item 8) In the electric working vehicle 1 according to item 7, the controller 11 is configured or programmed to continue the work-and-travel if the estimated electric power consumption is less than the first permissible value, and perform the first stop control when the vehicle body 2 reaches the first predetermined point.

With the configuration of Item 8 described above, the electric working vehicle 1 and the working device 4 can perform the work to the first predetermined point without stopping the PTO shaft 7j in response to the instruction from the user, and overdischarge of the battery 12 can be prevented or reduced.

(Item 9) The electric working vehicle 1 according to item 7 or 8, further including at least one of a memory or a storage 11b to store a planned travel route Z1 for the vehicle body 2 to travel and for the working device 4 to perform the work in the agricultural field H1, wherein the controller 11 is configured or programmed to, while performing the work-and-travel based on the planned travel route Z1, determine that the first predetermined point is one P2a of end points P2 of straight portions Z1a included in the planned travel route Z1 that is present in a direction of travel of the vehicle body 2 and that is closest from a position of the vehicle body 2, calculate an estimated travel distance to be traveled by the vehicle body 2 to reach the one P2a of the end points that is closest from the position of the vehicle body 2 based on the planned travel route Z1, and calculate the estimated electric power consumption corresponding to the first working device based on the estimated travel distance.

With the configuration of Item 9 described above, the estimated electric power consumption to the closest one end point P2a of the plurality of end points P2 that are the turning points of the planned travel route Z1 is calculated. Thus, if the estimated electric power consumption is less than the first permissible value, the work can be performed to the closest end point P2a in response to the instruction from the user. Thereafter, it is possible to eliminate or reduce the likelihood that, for example, the electric working vehicle 1 enters a worked area or an unworked area of the agricultural field H1 and damages the worked area or the unworked area. Furthermore the estimated electric power consumption corresponding to the first working device is calculated based on the estimated travel distance. Thus, performance of work of the electric working vehicle 1 and the working device 4 can be ensured, and the first stop control can be appropriately performed based on the estimated electric power consumption to reduce the electric power consumption.

(Item 10) In the electric working vehicle 1 according to any one of items 5 to 9, the controller 11 is configured or programmed to, when the type of the working device 4 is the second working device, cause a user interface to output second information Va2 asking whether raising the working device 4 is acceptable or not, and perform the second stop control when an instruction to accept raising the working device 4 is received via the user interface.

With the configuration of Item 10 described above, the lift actuator is caused to raise the work tool of the working device 4 to cause the working device 4 to stop performing the work after the acceptance is obtained from the user. Thus, it is possible to eliminate or reduce the likelihood that the user has a sense of distrust in the operation of the electric working vehicle 1. Furthermore, he user can determine whether to stop or continue the work in consideration of the work state of the electric working vehicle 1 and the working device 4, and thus convenience is improved.

(Item 11) The electric working vehicle 1 according to item 10, further including a position detector 23 to detect a position of the vehicle body 2 using a satellite positioning system, wherein the controller 11 is configured or programmed to, when an instruction to not accept raising the working device 4 is received via the user interface, calculate estimated electric power consumption which is an electric power estimated to be consumed by the electric working vehicle 1 if the work-and-travel is continued until the vehicle body 2 reaches a first predetermined point, and perform the second stop control if the estimated electric power consumption is equal to or greater than a second permissible value.

With the configuration of Item 11 described above, if the electric working vehicle 1 continues to perform the work-and-travel without raising the work tool of the working device 4 in response to the instruction from the user, the second stop control can prevent or reduce overdischarge of the battery 12.

(Item 12) In the electric working vehicle 1 according to item 11, the controller 11 is configured or programmed to continue the work-and-travel if the estimated electric power consumption is less than the second permissible value, and perform the second stop control when the vehicle body 2 reaches the first predetermined point.

With the configuration of Item 12 described above, the electric working vehicle 1 and the working device 4 can perform the work to the first predetermined point without raising the work tool of the working device 4 in response to the instruction from the user, and overdischarge of the battery 12 can be prevented or reduced.

(Item 13) The electric working vehicle 1 according to item 11 or 12, further including at least one of a memory or a storage 11b to store a planned travel route Z1 for the vehicle body 2 to travel and for the working device 4 to perform the work in the agricultural field H1, wherein the controller 11 is configured or programmed to, while performing the work-and-travel based on the planned travel route Z1, determine that the first predetermined point is one P2a of end points P2 of straight portions Z1a included in the planned travel route Z1 that is present in a direction of travel of the vehicle body 2 and that is closest from a position of the vehicle body 2, calculate an estimated travel distance to be traveled by the vehicle body 2 to reach the one P2a of the end points that is closest from the position of the vehicle body 2 based on the planned travel route Z1, and calculate the estimated electric power consumption corresponding to the second working device based on the estimated travel distance.

With the configuration of Item 13 described above, the estimated electric power consumption to the closest one end point P2a of the plurality of end points P2 that are the turning points of the planned travel route Z1 is calculated. Thus, if the estimated electric power consumption is less than the first permissible value, the work can be performed to the closest end point P2a in response to the instruction from the user. Thereafter, it is possible to eliminate or reduce the likelihood that, for example, the electric working vehicle 1 enters a worked area or an unworked area of the agricultural field H1 and damages the worked area or the unworked area. Furthermore, the estimated electric power consumption corresponding to the second working device is calculated based on the estimated travel distance. Thus, performance of work of the electric working vehicle 1 and the working device 4 can be ensured, and the second stop control can be appropriately performed based on the estimated electric power consumption to reduce the electric power consumption.

(Item 14) In the electric working vehicle 1 according to any one of items 5 to 13, the controller 11 is configured or programmed to, when the type of the working device 4 is a third working device which differs from the first working device and the second working device, cause a user interface to output third information Va3 suggesting that the working device 4 be detached from the vehicle body 2.

With the configuration of Item 14 described above, when the working device 4 connected to the electric working vehicle 1 is the third working device that cannot automatically stop the work, the user is caused to detach the working device 4. Thus, the load on the electric working vehicle 1 can be reduced and the electric power consumption can be reduced.

(Item 15) The electric working vehicle 1 according to item 14, further including a position detector 23 to detect a position of the vehicle body 2 using a satellite positioning system, wherein the controller 11 is configured or programmed to calculate estimated electric power consumption which is an electric power estimated to be consumed by the electric working vehicle 1 if the work-and-travel or a travel of the electric working vehicle 1 is continued until the vehicle body 2 reaches a second predetermined point, and cause the user interface to output the third information Va3 if the estimated electric power consumption is equal to or greater than a third permissible value.

With the configuration of Item 15 described above, if the estimated electric power consumption required for the electric working vehicle 1 to perform the work-and-travel or the travel-without-work to the second predetermined point is less than the third permissible value, the third information Va3 is not output. Thus, the electric power consumption can be reduced. In contrast, if the estimated electric power consumption is equal to or greater than the third permissible value, the third information Va3 is output to cause the user to detach the working device 4. Thus, the load on the electric working vehicle 1 can be reduced, the electric power consumption can be reduced, and overdischarge of the battery 12 can be prevented or reduced.

(Item 16) The electric working vehicle 1 according to item 15, further including at least one of a memory or a storage 11b to store map information relating to a region including the agricultural field H1, wherein the controller 11 is configured or programmed to determine that the second predetermined point is a storage location of the electric working vehicle 1 in the region based on the map information, calculate an estimated travel distance to be traveled if the travel of the electric working vehicle 1 is continued until the vehicle body 2 reaches the storage location based on the map information, and calculate the estimated electric power consumption based on the estimated travel distance.

With the configuration of Item 16 described above, the estimated electric power consumption required for the electric working vehicle 1 to travel to the storage location can be calculated. Then, if the estimated electric power consumption is less than the third permissible value, the third information Va3 is not output. Thus, the electric power consumption is reduced, and the electric working vehicle 1 can be caused to travel to the storage location although the user does not detach the working device 4.

(Item 17) The electric working vehicle 1 according to any one of items 2 to 17, further including a position detector 23 to detect a position of the vehicle body 2 using a satellite positioning system, and a communication interface (communication device, wide-area communication module) 24 to communicate wirelessly with an external device 41, 42, 43 (server 41, terminal device 42, and remote device 43), wherein the controller 11 is configured or programmed to calculate a traveled route traveled by the vehicle body 2 and an orientation of the vehicle body 2 based on time-series position data of the vehicle body 2, when the state of charge is less than a third threshold which is less than the second threshold, generate status information including at least one of the position of the vehicle body 2, the orientation of the vehicle body 2, the traveled route, or the device information, and cause the communication interface 24 to transmit the status information to the external device 41, 42, 43 (at least one of the server 41, the terminal device 42, or the remote device 43).

With the configuration of Item 17 described above, the status information of the electric working vehicle 1 can be transmitted to the external device 41, 42, or 43 before the electric power stored in the battery 12 is completely used. Then, even when the electric power stored in the battery 12 is completely used and the electric working vehicle 1 is stopped due to power stop, the electric working vehicle 1 can be appropriately relieved based on the status information.

(Item 18) In the electric working vehicle 1 according to any one of items 2 to 17, the controller 11 is configured or programmed to perform a third stop control when the state of charge is less than a third threshold which is less than the second threshold. The controller 11 is configured or programmed to, in the third stop control, cause the at least one inverter-for-travel 14Lf, 14Rf, 14Lr, 14Rr and the at least one motor-for-travel 3Lf, 3Rf, 3Lr, 3Rr to stop rotating the driving wheels 5Lf, 5Rf, 5Lr, 5Rr to cause the vehicle body 2 to stop traveling.

With the configuration of Item 18 described above, it is possible to eliminate or reduce the likelihood that the battery 12 will be completely discharged and deteriorated.

(Item 19) The electric working vehicle 1 according to any one of items 1 to 18, further including an externally power-supplying circuit 32 to supply electric power from the battery 12 to an external device, wherein the controller 11 is configured or programmed to, when the state of charge is less than a threshold (second threshold) and the type of the working device 4 is a fourth working device, perform a fourth stop control to stop the work. The fourth working device is configured to be driven by the electric power supplied from the externally power-supplying circuit 32. The controller 11 is configured or programmed to, in the fourth stop control, stop the electric power from being supplied from the externally power-supplying circuit 32 to the working device 4 by turning off a switch in the externally power-supplying circuit 32.

With the configuration of Item 19 described above, when the working device 4 connected to the electric working vehicle 1 is not the first working device of the PTO support type, is not the second working device of the raised/lowered type and the ground contact type, but is the fourth working device of the electric type, the electric power is stopped from being supplied from the externally power-supplying circuit 32 to the working device 4 to stop the work. Thus, the electric power consumption can be reduced. Accordingly, the working device 4 is caused to stop performing the work according to the state of charge of the battery 12 and the type of the working device 4. Thus, the flexibility of power saving of the electric working vehicle 1 can be further improved.

(Item 20) The electric working vehicle 1 according to any one of items 1 to 19, further including a hydraulic pump 31p to deliver hydraulic fluid, a motor-for-pump 31m which is an electric motor to drive the hydraulic pump 31p, an inverter-for-pump 31i to supply electric power from the battery 12 to the motor-for-pump 31m to drive the motor-for-pump 31m, and an externally fluid-supplying circuit 31c to supply the hydraulic fluid to an external device, wherein the controller 11 is configured or programmed to, when the state of charge is less than a threshold (second threshold) and the type of the working device is a fifth working device, perform a fifth stop control to stop the work. The fifth working device is configured to be driven by a pressure of the hydraulic fluid supplied from the externally fluid-supplying circuit 31c. The controller is configured or programmed to, in the fifth stop control, stop the hydraulic fluid from being supplied from the externally fluid-supplying circuit 31c to the working device 4 by closing a control valve 31d provided in the externally fluid-supplying circuit 31c.

With the configuration of Item 20 described above, when the working device 4 connected to the electric working vehicle 1 is not the first working device of the PTO support type, is not the second working device of the raised/lowered type and the ground contact type, but is the fifth working device of the hydraulic type, the hydraulic fluid is stopped from being supplied from the externally fluid-supplying circuit 31c to the working device 4 to stop the work. Thus, the electric power consumption can be reduced. Accordingly, the working device 4 is caused to stop performing the work according to the state of charge of the battery 12 and the type of the working device 4. Thus, the flexibility of power saving of the electric working vehicle 1 can be further improved.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric working vehicle comprising:
driving wheels for travel attached to a vehicle body;
at least one motor-for-travel which is at least one electric motor to drive the driving wheels;
a battery;
at least one inverter-for-travel to supply electric power from the battery to the at least one motor-for-travel to drive the at least one motor-for-travel;
a power take-off (PTO) shaft;
a motor-for-PTO which is an electric motor to drive the PTO shaft;
an inverter-for-PTO to supply electric power from the battery to the motor-for-PTO to drive the motor-for-PTO;
a battery management system to monitor a state of the battery;
an input interface to receive input of device information relating to a working device connected to the vehicle body; and
a controller configured or programmed to cause the at least one inverter-for-travel to control the at least one motor-for-travel, cause the inverter-for-PTO to control the motor-for-PTO, and control a lift actuator to raise and lower the working device; wherein
the controller is configured or programmed to:
perform a work-and-travel in which the controller causes the at least one motor-for-travel to drive the driving wheels to cause the vehicle body to travel and causes the working device to perform work in an agricultural field;
determine a type of the working device based on the device information; and
according to a state of charge of the battery detected by the battery management system and the type of the working device, control at least one of the motor-for-PTO or the lift actuator to cause the working device to stop performing the work.

2. The electric working vehicle according to claim 1, wherein the controller is configured or programmed to:
perform the work-and-travel when the state of charge is equal to or greater than a first threshold;
when the state of charge is less than the first threshold, perform the work-and-travel while limiting the electric power supplied by the at least one inverter-for-travel to the at least one motor-for-travel; and
when the state of charge is less than a second threshold which is less than the first threshold during the work-and-travel, control at least one of the motor-for-PTO or the lift actuator based on the type of the working device to stop the work and continue to cause the vehicle body to travel.

3. The electric working vehicle according to claim 1, wherein the controller is configured or programmed to, when the state of charge is less than a threshold, control at least one of the motor-for-PTO or the lift actuator based on the type of the working device to stop the work.

4. The electric working vehicle according to claim 1, wherein the controller is configured or programmed to:
when the state of charge is less than a threshold during the work-and-travel, perform at least one of a first stop control or a second stop control based on the type of the working device to stop the work;
in the first stop control, cause the inverter-for-PTO and the motor-for-PTO to stop driving the PTO shaft to stop driving a rotor of the working device connected to the PTO shaft; and
in the second stop control, cause the lift actuator to raise the working device to bring the working device into a predetermined position in which at least a work tool of the working device is not in contact with a ground surface.

5. The electric working vehicle according to claim 4, wherein the controller is configured or programmed to:
perform the first stop control when the type of the working device is a first working device to be driven by a driving force of the PTO shaft; and
perform the second stop control when the type of the working device is a second working device to be raised and lowered by the lift actuator and to perform the work while in contact with the ground surface.

6. The electric working vehicle according to claim 5, wherein the controller is configured or programmed to:
when the type of the working device is the first working device, cause a user interface to output first information asking whether stopping the PTO shaft is acceptable or not; and
perform the first stop control when an instruction to accept stopping the PTO shaft is received via the user interface.

7. The electric working vehicle according to claim 6, further comprising a position detector to detect a position of the vehicle body using a satellite positioning system; wherein
the controller is configured or programmed to:
when an instruction to not accept stopping the PTO shaft is received via the user interface, calculate estimated electric power consumption which is an electric power estimated to be consumed by the electric working vehicle if the work-and-travel is continued until the vehicle body reaches a first predetermined point; and
perform the first stop control if the estimated electric power consumption is equal to or greater than a first permissible value.

8. The electric working vehicle according to claim 7, wherein the controller is configured or programmed to continue the work-and-travel if the estimated electric power consumption is less than the first permissible value, and perform the first stop control when the vehicle body reaches the first predetermined point.

9. The electric working vehicle according to claim 7, further comprising at least one of a memory or a storage to store a planned travel route for the vehicle body to travel and for the working device to perform the work in the agricultural field; wherein
the controller is configured or programmed to:
while performing the work-and-travel based on the planned travel route, determine that the first predetermined point is one of end points of straight portions included in the planned travel route that is present in a direction of travel of the vehicle body and that is closest from a position of the vehicle body;
calculate an estimated travel distance to be traveled by the vehicle body to reach the one of the end points that is closest from the position of the vehicle body based on the planned travel route; and
calculate the estimated electric power consumption corresponding to the first working device based on the estimated travel distance.

10. The electric working vehicle according to claim 5, wherein the controller is configured or programmed to:
when the type of the working device is the second working device, cause a user interface to output second information asking whether raising the working device is acceptable or not; and
perform the second stop control when an instruction to accept raising the working device is received via the user interface.

11. The electric working vehicle according to claim 10, further comprising a position detector to detect a position of the vehicle body using a satellite positioning system; wherein
the controller is configured or programmed to:
when an instruction to not accept raising the working device is received via the user interface, calculate estimated electric power consumption which is an electric power estimated to be consumed by the electric working vehicle if the work-and-travel is continued until the vehicle body reaches a first predetermined point; and
perform the second stop control if the estimated electric power consumption is equal to or greater than a second permissible value.

12. The electric working vehicle according to claim 11, wherein the controller is configured or programmed to continue the work-and-travel if the estimated electric power consumption is less than the second permissible value, and perform the second stop control when the vehicle body reaches the first predetermined point.

13. The electric working vehicle according to claim 11, further comprising at least one of a memory or a storage to store a planned travel route for the vehicle body to travel and for the working device to perform the work in the agricultural field; wherein
the controller is configured or programmed to:
while performing the work-and-travel based on the planned travel route, determine that the first predetermined point is one of end points of straight portions included in the planned travel route that is present in a direction of travel of the vehicle body and that is closest from a position of the vehicle body;
calculate an estimated travel distance to be traveled by the vehicle body to reach the one of the end points that is closest from the position of the vehicle body based on the planned travel route; and
calculate the estimated electric power consumption corresponding to the second working device based on the estimated travel distance.

14. The electric working vehicle according to claim 5, wherein the controller is configured or programmed to, when the type of the working device is a third working device which differs from the first working device and the second working device, cause a user interface to output third information suggesting that the working device be detached from the vehicle body.

15. The electric working vehicle according to claim 14, further comprising a position detector to detect a position of the vehicle body using a satellite positioning system; wherein
the controller is configured or programmed to:
calculate estimated electric power consumption which is an electric power estimated to be consumed by the electric working vehicle if the work-and-travel or a travel of the electric working vehicle is continued until the vehicle body reaches a second predetermined point; and
cause the user interface to output the third information if the estimated electric power consumption is equal to or greater than a third permissible value.

16. The electric working vehicle according to claim 15, further comprising at least one of a memory or a storage to store map information relating to a region including the agricultural field; wherein
the controller is configured or programmed to:
determine that the second predetermined point is a storage location of the electric working vehicle in the region based on the map information;
calculate an estimated travel distance to be traveled if the travel of the electric working vehicle is continued until the vehicle body reaches the storage location based on the map information; and
calculate the estimated electric power consumption based on the estimated travel distance.

17. The electric working vehicle according to claim 2, further comprising:
a position detector to detect a position of the vehicle body using a satellite positioning system; and
a communication interface to communicate wirelessly with an external device; wherein
the controller is configured or programmed to:
calculate a traveled route traveled by the vehicle body and an orientation of the vehicle body based on time-series position data of the vehicle body;
when the state of charge is less than a third threshold which is less than the second threshold, generate status information including at least one of the position of the vehicle body, the orientation of the vehicle body, the traveled route, or the device information; and
cause the communication interface to transmit the status information to the external device.

18. The electric working vehicle according to claim 2, wherein the controller is configured or programmed to:
perform a third stop control when the state of charge is less than a third threshold which is less than the second threshold; and
in the third stop control, cause the at least one inverter-for-travel and the at least one motor-for-travel to stop rotating the driving wheels to cause the vehicle body to stop traveling.

19. The electric working vehicle according to claim 1, further comprising an externally power-supplying circuit to supply electric power from the battery to an external device; wherein
the controller is configured or programmed to, when the state of charge is less than a threshold and the type of the working device is a fourth working device, perform a fourth stop control to stop the work;
the fourth working device is configured to be driven by the electric power supplied from the externally power-supplying circuit; and
the controller is configured or programmed to, in the fourth stop control, stop the electric power from being supplied from the externally power-supplying circuit to the working device by turning off a switch in the externally power-supplying circuit.

20. The electric working vehicle according to claim 1, further comprising:
a hydraulic pump to deliver hydraulic fluid;
a motor-for-pump which is an electric motor to drive the hydraulic pump;
an inverter-for-pump to supply electric power from the battery to the motor-for-pump to drive the motor-for-pump; and
an externally fluid-supplying circuit to supply the hydraulic fluid to an external device; wherein
the controller is configured or programmed to, when the state of charge is less than a threshold and the type of the working device is a fifth working device, perform a fifth stop control to stop the work;
the fifth working device is configured to be driven by a pressure of the hydraulic fluid supplied from the externally fluid-supplying circuit; and
the controller is configured or programmed to, in the fifth stop control, stop the hydraulic fluid from being supplied from the externally fluid-supplying circuit to the working device by closing a control valve provided in the externally fluid-supplying circuit.
